(19) United States
(12) Patent Application Publication
(10) Pub. No.: US 2025/0028961 A1
(43) Pub. Date: Jan. 23, 2025

(54) SEGMENT SEQUENCING ARTIFICIAL INTELLIGENCE TOPOLOGY WITH ADAPTIVE MODIFICATION

(71) Applicant: Fantagic Holdings LLC, Naples, FL (US)

(72) Inventors: James Duane Bennett, Naples, FL (US); Bindu Rama Rao, Naples, FL (US)

(21) Appl. No.: 18/778,120

(22) Filed: Jul. 19, 2024

Related U.S. Application Data
(60) Provisional application No. 63/528,145, filed on Jul. 21, 2023.

(51) Int. Cl. G06N 3/082

(52) U.S. Cl. CPC G06N 3/082

(57) ABSTRACT

Optional segmented generative AI (Artificial Intelligence) topologies with multiple AI type outputs participate to serve overall AI generation objectives. Multiple remote and local topology nodes within overall topology segments utilize pattern based influence along with both inner and inter segment influence to adapt as new generations occur, to maintain context and to address changing circumstances. Outside influence delivers such change notifications. AI output and input interface elements provide some such change notifications and provide alternatives to conventional driver based circuit architectures. Support processing nodes, discriminative AI elements, generative AI elements along with outside influence from input, output and communication circuitry along with other outside interactions are arranged in sub-segments that are carried out to deliver generated pieces of a multimedia based objective. Segment breaks allow for user review interaction along a segmented generation flow for editing and regeneration interactions. Personalized and random elements of influence, e.g., via objective, episodic and content patterns constrain AI generation via influence to hold to expected and desired output flow across segments. Inner and inter segment influence is delivered in a feed forward, feedback and cyclical manner, wherein correlation evaluations play part. Too much or too little correlation also drives regeneration cycling. Random influence via inherent and random tags requiring population before application within patterns. Random tags may comprise tree structures of randomness generated in lists from private and public data.

### RELATED APPLICATIONS

The present application incorporates by reference herein in its entirety and for all purposes, U.S. Provisional Application Ser. No. 63/525,817, filed Jul. 10, 2023, entitled “Multi-Node Influence Based Artificial Intelligence Topology” (EFS ID: 48272269; Atty. Docket No. GA01).

### BACKGROUND

### 1. Technical Field

The present invention relates generally to generative and discriminative artificial intelligence; and, more particularly, to adaptive remote and local multi-node artificial intelligence topologies serving a common functional objective.

### 2. Related Art

Basic training and deployment of single nodes of generative and discriminative Artificial Intelligence (hereinafter “AI”) is commonplace. Various AI models currently exist while other models are under development to gain high quality AI output and discrimination. In addition to the model's themselves, the amount of training data utilized continues to grow with quality of training data also becoming more important. Most AI models operate in the cloud due to: a) heightened processing, speed, and storage demands; b) massive numbers of user requests to service; and c) design goals of responding to user service requests that have little subject matter bounds. Because of these factors, users will inevitably end up being assessed costs associated with such cloud based AI services, e.g., in advertising or periodic charges to use such AI models.

Moreover, if the cloud AI service receives too many simultaneous requests beyond its capability or when a denial of service attack takes place, servicing user requests becomes unpredictable. Many users will find unacceptable delays or are guided to try again later. And when a user's device is offline, such cloud based AI services become fully unavailable.

Turning to the cloud based AI models themselves, they are designed and trained to operate as single node AI elements, for example, taking in user text queries and output anything such as a poem, short story, or summary description. This comprises only a fraction of what each user would like to accomplish in their particular overall goal underlying their desire to use the single node AI service.

These and other limitations and deficiencies associated with the related art may be more fully appreciated by those skilled in the art after comparing such related art with various aspects of the present invention as set forth herein with reference to the figures.

### BRIEF SUMMARY OF THE INVENTION

The present invention is directed to apparatus and methods of operation that are further described in the following Brief Description of the Drawings, the Detailed Description of the Invention, and the claims. Other features and advantages of the present invention will become apparent from the following detailed description of the invention made with reference to the accompanying drawings.

### BRIEF DESCRIPTION OF THE DRAWINGS

FIG. 1 is a schematic diagram illustrating exemplary circuitry supporting adaptable multi-node artificial intelligence operations carried out in a segmented sequence in a defined topology and with influence balancing.

FIG. 2 is a schematic diagram illustrating several exemplary embodiments of a corresponding set of elements introduced in FIG. 1, wherein a segment sequence definition is set forth in accordance with various aspects of the present invention;

FIG. 3 is a schematic block diagram illustrating exemplary circuitry configured to conduct artificial intelligence generation on a segment by segment basis and guided by influence from a variety of exemplary sources;

FIG. 4 is a schematic diagram illustrating a first segment topology and overall functionality carried out by remote and local circuitry to process a first segment of artificial intelligence generation in accordance with one embodiment of the present invention;

FIG. 5 is a schematic diagram illustrating again usage of a segment topology by remote and local circuitry to process a plurality of middle segments after the first segment generation has completed as described with reference to FIG. 4;

FIG. 6 is a schematic diagram illustrating exemplary processing by the local and remote circuitry to generate the final segment after the plurality of middle segments have been completed as described with reference to FIG. 5;

FIG. 7 is a schematic block diagram that illustrates an exemplary deployment of artificial intelligence elements in association with both input and output circuitry for use in influencing and triggering segmented generation and to minimize needs to configure input and output flow for each particular local configuration;

FIG. 8 is a flow diagram illustrating yet other aspects of the present invention in an exemplary segment by segment progression of an overall generation artificial intelligence objective, and where user feedback such as dissatisfaction with a segment generation can trigger a rerun of one, many or all prior generated segments and with user feedback being used to influence reruns;

FIG. 9 is a flow diagram illustrating another exemplary segment by segment progression of an overall generation artificial intelligence objective, and wherein a rerun of one, many or all prior generated segments is triggered based a degree of correlation determination; and

FIG. 10 is a structural database diagram illustrating digital rights management, authorization, payment collection, and usage control of artificial intelligence elements trained on particular users' owned training datasets that may be used in accordance with the present invention to address both privacy and ownership rights.

### DETAILED DESCRIPTION OF THE DRAWINGS

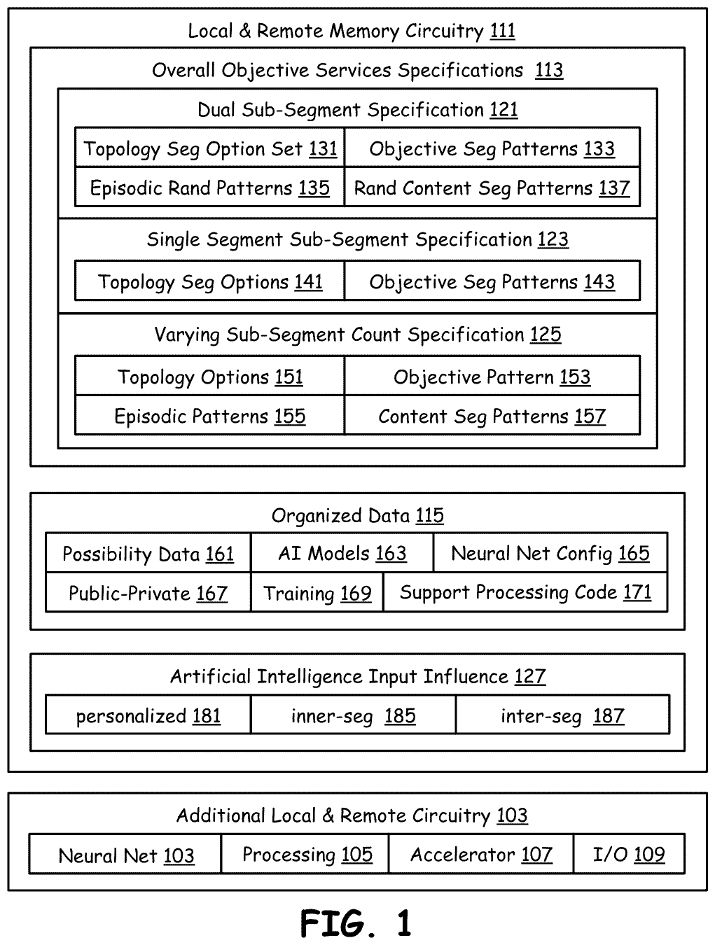

FIG. 1 is a schematic diagram illustrating exemplary local and remote circuitry supporting adaptable multi-node artificial intelligence operations carried out using segmented and sub-segmented topologies to carry out selected overall AI (Artificial Intelligence) generation objectives. Users may deploy any number of specifications stored within local and remote memory circuitry 111. Each of the stored specifications direct processing circuitry 105 in carrying out an overall AI generation objective. For example, as illustrated, three different overall AI generation objectives are defined by a dual sub-segment specification 121, a single segment with sub-segments specification 123 and a varying sub-segment count specification 125). Such specifications are stored and available as overall objective services specifications 113. Processing circuitry 105, a part of additional local and remote circuitry 103, selects from the available specifications of the overall objective services specifications 113 to carry out a desired overall AI generated objective.

Also within the local and remote memory circuitry 111, artificial intelligence (AI) input influence 127 can be found which the processing circuitry 105 applies as needed to carry out influence from personalized 181, inner segment 185 and cross segment 187 influence data. The personalized influence data 181 may originate from public or private data 167 of organized data 115. Public and private data 167 is also used to construct possibility data 161 for use in injecting a bit of user tailored randomness into the overall AI generation output.

Within the organized data 115, AI software models 163 are stored that can be accessed as needed to perform all or part of at least some functionality specified within any specification of the overall objective services specifications 113. To carry out a particular specification, the processing circuitry 105 may choose to deploy neural network circuitry 103 and/or the software AI models 163. For example, topologies of for serving a particular overall AI generative objective, e.g., topology segment option set 131 of the dual sub-segment specification 121, may call for support processing topology nodes as well as generative and discriminative AI topology nodes with organized interconnections needed to carry out the desired functionality. The processing circuitry 105 manages this by either performing all of the processing itself as defined by a particular one of the AI software models 163 which embodies and encompasses at least a portion of overall topology. That is, each of the AI software models 163 define therewithin at least a portion of the overall topology needed to carry out a selected overall AI generated objective. One AI software model might only perform a single generative AI node function. Another AI software model might include that generative AI node plus all other supporting node functions carrying a full sub-segment operation. Yet other AI software models may perform a full single segment operation including all sub-segment operations needed therein. And similarly, AI software models may contain all of the topology nodal functionality needed to carry out the entire overall AI generated objective.

The processing circuitry 105 may carry out the AI software model 163 functionality using its own processing unit circuitry with access to accelerator circuitry 107. Such accelerator circuitry 107 being designed to speed up the software neural network processing found within the AI software models 163. Alternatively, or in addition to the AI software models 163, the processing circuitry 105 may utilize the neural network circuitry 103 to carry out the generative and discriminative AI functionality. The neural net circuitry 103 is carried out in one or more dedicated semiconductor neural network circuits. For example, some neural network circuits maybe involve analog neural network arrays, pulse code modulated arrays, combinations of analog and digital neural network arrays, and fully digital circuit representations of a neural network array. The processing circuitry 105 may utilize one of these types of the neural network circuitry 103 to carry out particular topology functionality set forth within a specification within the overall objective services specifications 113. Beyond the operation of such portions of the topology nodes being handled by the neural network circuitry 103, any needed other nodal elements and topology flow is handled by the processing circuitry 105 with access if needed to one or more of the AI software models 163 and the accelerator circuitry 107.

The organized data 115 also contains training data 169 for training of any neural network whether carried out in circuitry or within a software model counterpart. Once trained, parameter data associated with the neural network circuitry 103 can be copied, stored, reused or circulated as neural network configuration data 165. Thus, the neural network circuitry 103 can be trained by many independent sets of the training data 169 for particular AI generative performance and then later the neural network configuration data 165 can be swapped out as needed to carry out one of many overall AI generative objectives in which the neural network circuitry 103 operates in differing ways according to differing trainings.

Many of the overall AI generative objectives that may be serviced utilize input and output circuitry 109. For example, user input data from user input circuitry may be used to influence the generation associated therewith. User output devices such as a screen and speakers, output elements associated with the output circuitry of the input and output circuitry 109, may also be called for as part of the overall AI generative objective.

The processing circuitry 105 also carries out particular functionality associated with support processing nodes within topologies as defined within support processing code 171. For example, the support processing code 171 might contain code including but not limited to lemmatization, stemming, influence balanced mergers, relationship and feature recognition, repeat reduction, denoising, tokenization, vectorization, and any other support processing needed to prepare or gather inputs as well as post process outputs of AI nodes within any overall segmented and sub-segmented topology. Some of the support processing code 171 is also included within some of the AI software models 163 such as when one of the AI software models spans beyond a single neural network software embodiment and to further carry out support processing in association therewith.

As mentioned, the overall objective services specifications 113 many include any number of specifications which each address an overall AI generative objective. Three examples of such specifications for illustrative purposes are shown. The dual sub-segment specification 121 defines an overall functionality for addressing a single overall AI generative objective. For example, it may support generation of a children's electronic storybook where each page comprises an image and corresponding paragraph of text, wherein each page is processed as a segment and with the text paragraph AI generation being handled in a first sub-segment topology that then influences the image AI generation being handled in a second sub-segment topology. As the child interacts through an input element associated with input circuitry of the input and output circuitry 109 indicating a desire to turn a page, a next segment generation is activated. In this way, segment (page generation) only happens when requested by the child and the storybook might be never-ending. Alternatively, as illustrated, such electronic storybook does come to last page (last segment) end, but supports further such storybooks in an episodic manner.

To carry out this overall AI generative objective, the dual sub-segment specification 121 utilizes topology definitions, wherein each segments' sub-segment topologies are defined within a topology segments with option set 131. Optional because there are many topology options to carry out a desired segment functionality. For example, an image can be generated first in the first segment's image generating topology sub-segment which is then used to influence the paragraph generating AI topology of the second sub-segment, or vice versa. In addition, different support processing nodes might be used within a sub-segment and so on. Running local or remote on any number of topology node options are also contemplated, and thus the processing circuitry 105 must identify an appropriate topology for a particular sub-segment and for each particular segment wherein many options are available.

The dual sub-segment specification 121 also includes objective segment patterns 133, episodic random patterns 135, and random content segment patterns 137. All of these patterns are used to influence the segmentation to coax underlying AI elements to generate output in an attempt to best meet the overall AI segmented generation objectives. This influence is especially important where AI elements are more generally trained and require input influence to control output. The more specifically trained the AI element, the less influence may be needed.

Also within the overall objective services specifications 113, another exemplary specification, a single segment with sub-segments specification 123, can be found to illustrate that any number of segments may be defined from endless to even a single segment to serve a particular overall AI generative objective. For example, the single segment with sub-segment specification 123 may be used to generate a single page (single segment) sales brochure with one sub-segment utilizing a first AI node to generate functional detail text paragraph describing a product. A second sub-segment operating independently and in parallel with the first sub-segment generates using a second AI node several attention grabbing sentences including a title, on-sale and best performance type output. A third sub-segment also generates from a third AI node which receives an image of the product and contorts such image into an acceptable perspective within a background. These generated outputs are then organized into a single sheet image for printing and dissemination. This single segment with subs-segments specification 123 can then be reused for other products to quickly generate brochures when new products become available.

To carry out this brochure generation objective, specifications for the first, second and third sub-segment topologies can be found in the topology segment options 141, where for example, many options exist for carrying out the overall AI generative objectives and the processing circuitry 105 makes the optional selections based on many factors, e.g., cost, current node loading, device capability, privacy, security, user's choice, generation quality, and so on. This brochure example does not employ episodic or random content patterns as might be expected. The objective segment pattern 143 though, with sub-segment objective sub-patterns, is included. For example, to coax: a) first sub-segment generation to abide by a maximum and minimum paragraph size; b) the second sub-segment generation to ignore punctuation, control word sequence length, and use active versus passive style; and c) the third sub-segment generation to include happy family members and a living room background.

A third exemplary specification, the varying sub-segment count specification 125, is depicted to illustrate that not all overall AI generative objectives involve similar segments. Some segments may comprise a single topology sub-segment, while others utilize multiple. Moreover, segment sizing might also adapt in length of generated output. For example, consider a generative AI solution, i.e., an overall AI segmented generation objective, wherein a full magazine is generated. Index page generation being a first segment, a subscription offer page for last segment along with a plurality of mixed advertiser segments and a plurality of article segments arranged in some mixed ordering between the first and last pages.

To carry this out, each article segment employs an article text generating AI node in a first article sub-segment whose generated text influences generation of an image by a second article sub-segment which includes an article image generating AI node. As part of the segmented process, advertisers generate their own advertisements such as by using the single segment with sub-segments specification 123 to generate brochure sized advertisements for inclusion into the overall segmented magazine generating process. That is, even different and fully separate segments may be used to generate elements in advance or in real time as needed, for inclusion into another overall segmented generation flow. As mentioned above, the brochure advertisement embodiment utilizes three sub-segments with three different generative output goals from the two sub-segment generations used to produce each article. With functionality mentioned herein, the varying sub-segment count specification 125 may also selectively employ episodic patterns 155 (for example to the index page segment generation) and content segment patterns 157 to drive certain magazine content subject matter in underlying AI generations. Objective patterns 153 being used to control the magazine layout and structure.

The local and remote memory circuitry 111 can also be shared across many remote locations and local user devices. They can be shared by many users as well and their user devices. Such sharing possibly involving digital rights management aspects and including associated payments for permanent sharing or even one time usage. In addition, the generated outputs for some or all of the overall objective services specifications 113 can be constrained for consumption by a particular user, but may also be shared amongst others with or without digital rights management and associated payments.

In this way, creation and sharing of partially created segments, partially created episodes, exchange of influences, etc., may not only allow broader consumption of the particular output in a particular format, such output can be used as input into yet further generative AI topologies to provide other, newer and even alternate media type outputs based thereon. For example, a children's storybook generated by one user's specification within the overall objective services specifications 113 can be used as an input generation to a segmented AI generating topology defined by a second user's screenplay writing topology based on a second user's specification with the overall objective services specifications 113. A third user having created a screenplay to cartoon video generation specification might then use the second user's screenplay to generate a cartoon. Or, the first user may generate all of these steps within one specification or by creating their own specification that steps through the three sub-specifications to fully generate the cartoon without any third party assistance. Such generation can be fully automatic or automated in that the first user steps through segment by segment and sub-segment by subsegment to approve of any generated output in the overall process. By stepping through at segment or sub-segment breaks, the user can approve generated outputs as is or deliver request to try again and even inject further influence or select another topology option for the generation reattempt.

Within the overall objective services specifications 113, three of many possible examples are provided each of which correspond to particular overall segmented AI generation objective. For example, a user may desire a segmented generation of a series of children's storybooks i.e., the overall segmented AI generation objective. To carry this out, each segment might correspond to a single page generation of a multi-page (multiple segment) storybook. Within a segment or page, a first sub-segment of AI generation might deliver a single paragraph of text within the overall story, while a second sub-segment is directed to AI generation of a single accompanying image relating to the generated text paragraph for that page (segment). How such overall segmented AI generation takes place can be defined, for example, within a dual sub-segment specification 121.

More specifically, for such storybook example, the processing circuitry 105 launches the overall segmented AI generation objective by accessing the dual sub-segment specification 121. With such access, the processing circuitry 105 first selects the first sub-segment topology to generate the first page text, i.e., the first segment text. To drive the underlying AI generation, a variety of influence is delivered to affect the AI generated output. In the present embodiment, there are three core types of patterns for use in influencing AI generation. Each of these three pattern types may contain pre-defined elements only, random elements only or a combination of both. The form of the influence depends on the nature of the AI node to be influenced. For example, an AI that responds to input text only to generates an output can only be influenced by text input, and thus a pattern must have textual elements. To influence an AI that receives an image input only requires a pattern to contain an image to deliver influence. An AI that receives both image and text can be influenced by either or both of text and image within a pattern.

Patterns may contain multiple or only one of many types of influence data, including but not limited to voice related input data, video related input data, text, image, audio related input data and so on. For example, a pattern, which serves a segment, may be constructed to serve each and every AI element within such segment and their may be a large number of such AI elements. And some AI elements may be capable of being influenced via multiple types of influence data. For terminology purposes, each segment (i.e., each segment of a plurality of segments designed to serve an overall AI generation objective) may be comprised of a plurality of sub-segments defined by a corresponding plurality of sub-topologies, with each sub-segment containing at least one AI element and often support processing elements as well. Patterns then can be broken down into sub-patterns where certain influence targets a corresponding certain AI element's input through which influence is delivered.

In particular, objective segment patterns 133 may, for example, define paragraph size limits, layout, image resolution, video clip length, overall segment to segment variations and characteristics, etc. Objective patterns generally seek to influence (or exert a certain degree of control) over formatting across segments and sub-segments, and often are designed to meet a user's expectations regarding the overall AI generation objective. Although not illustrated, random elements may be added to the objective segment patterns 133 such as where many acceptable formats are available and influencing randomness in the overall output generation may prove desirable with some objectives.

Random content segment patterns 137 may be constructed providing pattern elements requiring random population by the processing circuitry 105 (FIG. 1) each time a specification is carried out. Random element population may involve inherent randomness, such as date, temperature, lighting level, and so on. It may also be filled from particular lists of possibilities. For example, a “<family member name>” random element might get filled by random selection from a personalized list of that user's family members' names. Other of these types of lists to be used for random population may be provided by third party vendors or constructed by the user, generated locally from private user data, and/or extracted from search results (from databases, Internet search engines, etc.). Such possibility lists may also be generated from AI as well. Likewise, random population by inherency, such as by adding a date, temperature, background noise level, and so on, may be populated by the processing circuitry 105 by accessing data generated outside of the topology specification.

Like other patterns, content segment patterns need not be random or at least contain some pre-populated influence data, as randomness may be very beneficial to some overall AI generation objectives for some users, while other users find it annoying. Similarly, some other overall AI generation objectives may never benefit from random influence and randomness within any pattern type may be avoided.

To maintain context across a series of such storybooks, episodic random patterns 135 provide influence based not only on for example maintaining the same actor set such as reusing the same protagonists and antagonists, but introducing new storyline influences selected from a plurality of possibilities that might be pre-prepared by the third party vendor of this configuration of the dual sub-segment specification 121.

To explore details of the patterns set forth in the current embodiment of the present invention, we again return to the dual sub-segment specification 121. Therein we find the objective segment patterns 133, random content patterns 137, and episodic random patterns 135. For a first sub-segment, for example, a pattern from each of these three pattern types can be applied to influence the first AI generated output. Next, the processing circuitry 105 turns to the second sub-segment. Using a second sub-segment topology (i.e., found in the topology specification option selected for the first segment in the topology segments with option set 131), a further set of these three patterns are used to influence the second AI generation of the second sub-segment and so on across all segments and sub-segments needed to carry out the overall AI generation objectives.

For example, for the child's storybook embodiment described above, at least much of the pattern of the objective segment patterns 133 can be applied to all segments (pages) of the storybook. The objective pattern may involve image size, color palette, resolution and other constraints that all generated storybooks and storybook pages need to be constrained in their AI generations to meet the desired overall AI generative objective which includes being able to fit the appropriate page space with each image and paragraph of text.

Regarding episodic random patterns 135, a common image style might be randomly selected from a plurality of possible styles such as watercolor, pointillism, cartoon sketch, etc. But once selected, all pages of a storybook, and all storybook episodes, may be constrained through influence to such random selection. To carry this out, the pattern of the episodic random patterns 135 might include the randomized selection of an image style which is then populated into each episodic random pattern assigned to each segment. In addition, for future episode generations, the image style having been already randomly selected is also again fixed (populated) to such image style for application to any future storybooks in the episodic series. A slight alternative may be where episodic patterns only service a first segment (or limited number of segments) and wherein inter-segment influence carries the episodic pattern forward through segments not receiving the episodic pattern directly. And as can be appreciated, the objective, content and episodic patterns may inject influence across all or every segment and sub-segment, or only be applied to influence those segments and sub-segments that adequately serve the overall AI generation objective, and wherein inner-segment and inter-segment influence flows extend the impact of such pattern influence even in segments were patterns are not directly applied.

If instead of allowing episodic randomness to for example govern image style selection, a comic sketch style can be maintained across all episodes by adding fixed entries into the episodic pattern, while randomness can still be maintained therein for other elements of the episodic pattern. This mixed combination of fixed a randomly populated elements may be applied to all pattern types.

Once the first sub-segment AI generation of text and second sub-segment AI generation of image for a first page (segment) has completed, the processing circuitry 105 repeats this processing using the patterns next in line for the next segment generation and so on until the overall segmented AI generation objective has been reached, i.e., last segment (page) of the storybook has completed.

In addition to dual sub-segment specifications, there can be single to any number of generative AI based sub-segments for each segment. Moreover, the number of sub-segments per segment can vary for a particular configuration and differing overall AI generative objective. Likewise, there can be single segment to any number of segments designed to meet the specific goals of an overall AI generative objective. Sub-segments and segments can be executed in sequence and even partially or fully in parallel (the latter where a required ordered sequence such as a first AI outputs influencing a second AI output does not exist).

The topology segments with option set 131 may contain only a single sequence of segment/sub-segment topologies to service an entire overall AI generation objective. However, when there are various topological approaches to accomplishing such generation, the topology segments with option set 131 may have many options from which to choose. Moreover, as conditions change during the segment generation, selected options may also be changed in an adaptive way. For example, some topology nodes (e.g., AI nodes and support processing nodes) and entire segment or sub-segment topologies in whole or in part may have remote and local device counterparts. Selecting remote topology options at first may require a transition during segment generation to local counterparts for offline connectivity loss. Cost factors, quality, input associated events, digital rights and privacy issues, and even loading of either a remote or local topology node or communication pathway might affect topology option selection or adaptation by the processing circuitry 105.

Although they can be grouped together, broken apart, or even include others pattern types, all to any and even none of the three pattern types (with or without randomness) of the present embodiment may be used to support a particular specification within the overall objective services specifications 113. Certain overall AI generation objectives may find no benefit in such pattern influences. Other objectives may benefit from one or more or even all types of patterns. Thus, pattern usage depends on the particular needs and expectations associated with a particular overall AI generative objective.

In addition, pattern influence intensity can vary to best serve a particular overall objective. One pattern type may be more important than others or one with far lesser importance than others. This can be managed in at least two ways. First, by reducing the amount of influence data within a particular pattern. For example, constraining word count associated within one pattern might cause words of less importance to be abandoned in the influence delivery, and reducing word count reduces influence intensity. The second way is by prioritizing one pattern's influence over another in an influence balancing process carried out by the processing circuitry 105, often during a merger of multiple influence sources. Such influence balancing across patterns takes place according to merger support software to typically service an AI element have only a single input. If the AI element is configured with multiple inputs to serve corresponding multiple influence sources, the AI element can be trained to handle influence balancing internally.

As mentioned, objective patterns, e.g., the objective segment patterns 133, 143 and 153, place constraints on the segment and sub-segment generation to meet a user's expected output format associated with the overall AI generative objectives. For example, in single sub-segment specification that is defined to service a mystery novel generation objective (not shown but wherein a segment corresponds to a chapter), the objective segment patterns might include what is equivalent to “write a 20 page first chapter of a mystery novel introducing and describing the protagonists, background environment, and the mystery” while a final chapter's objective segment pattern might convey what is equivalent to “write a 20 page last chapter of the mystery novel revealing the identity of the antagonist that leads to a violent confrontation with protagonist barely managing to survive, and wherein the antagonist is captured and turned over to the police in the very end.”

Such examples of the objective segment patterns of course will be processed into a form that best delivers such influence pattern to the chapter generating AI. Such objective segment patterns, as with any objective segment pattern, may be prepared by a user or third party vendor and downloaded along the entire associated specification and stored within the overall objective services specifications 113. In addition, the objective segment patterns may be extracted from other human or AI generated works from which the current user or similar users have expressed as being of high quality. This extraction can be human based or a generative AI can be trained to evaluate a user's favorite mystery novel, for example, and prepare a chapter by chapter (i.e., segment by segment) set of objective segment patterns for storage, use and reuse as for example the objective segment patterns 133.

Similarly, random content patterns can be included or ignored for use with certain other overall AI generative objectives which do not benefit from personalization influence or other random influence. Assuming for example, a designer desires to offer an AI generated voice feed describing each days' trending search topics retrieved from a search engine's trending search list. The designer imagines an overall AI generative objective involving a first sub-segment based AI generating text, and a second sub-segment based AI generating therefrom corresponding voice output. For each segment, the designer also plans to use search engine provided trending topic lists of the top one hundred searches conducted each day. But because of time constraints associated with the daily overall audio feed length, each day only ten of the top one hundred will be randomly selected for inclusion. The designer also decides that there is no need for episodic patterns or random episodic patterns. Instead, only objective patterns and random content patterns are estimated to be required. The designer crafts one objective pattern comprising two objective sub-patterns, one for the first sub-segment to influence the text generation and the other for the second sub-segment to influence the voice generation. Regarding the former, the pattern might merely involve a number of word target and maximum length. Regarding the latter, the pattern might be to select the speaker voice from a plurality of available voices, and indicate the delivery tone, excitement level and delivery speed. For random content patterns, the designer plans on populating those with a random selection of a single one of the top one hundred trending topics with a total of ten patterns each identify one of the ten random selections. This is set up to randomly populate each day when generating the next day's voice feed.

There are also overall AI generative objectives that require no patterns at all or merely utilize one such as the single segment with sub-segments specification 123 which only employs an objective pattern 143—a single pattern for the single segment.

As mentioned, a segment with multiple sub-segments AI generations, may each be influenced by any number or no patterns. One pattern (or sub-pattern) may be reused across all segments, or merely be used once for a given segment and possibly replaced by other patterns specifically designed for each segment and together forming a pattern set. And, as mentioned before, patterns and sub-patterns need not be limited to associations with text but may extend to all other types of media. For example, if within a first segment only, a sub-segment topology includes an image to music generating AI, a pattern might also include an image as influence and so on. Not all segments need to maintain the identical topologies. Similarly, not all sub-segments need to be present across all segments. For example, an image generating sub-segment for a first page of a magazine article may only be used for the first page and thereafter, only generated page text is used without imagery.

As mentioned, the processing circuitry 105, in addition to managing deployment of generative specifications, provides processing support in accordance with the support processing code 171. In general terms, such support processing might include computations, algorithmic manipulations, data management, data transformations, etc. The neural network circuitry 103 can be configured to learn and be modeled based on relationships between input and output data that are nonlinear and complex. The accelerator circuitry 107 may perform any number of tasks such as real number mathematics, data manipulations, advanced matrix computations and so on.

Also mentioned, the organized data 115 serves as a repository of the training data 169 used to train the neural network circuitry 103 and the AI software models 163. The possibility data 161 provide one approach at facilitating dynamic creation of input influences as well as dynamic assembly of queries used to extract influence data.

Patterns may be loaded with a great amount of influence data or include very little depending on a pattern's value for a particular segment or across all segments of the overall AI generative objective. Such influence may also be balanced as it is combined with other influence sources or reduced in influence impact as even a particular user requires or exhibits preference therefor. For example, some readers seeking a novel generation will be amused to see their family members taking roles in the novel. Other readers will find this a distraction. To manage this, either the influence intensity of random content patterns (which influences the addition of family members into the cast), or may instead eliminate use of the random content patterns entirely. Such actions to balance (including decreasing or removing) influence may be responsive to user feedback, or may be automatically carried out after analyzing prior user preferences gathered from their previously favorite generated books.

Some patterns found with overall objectives services may be designed to prevent influence balancing. For example, a major movie blockbuster may offer a comic generating specification into the overall objective services specifications 113 for use in exchange for an annual fee. But the patterns they provide and associated influence balancing may not be modifiable. In this way, a certain quality can be maintained in all AI output generations that may themselves carry authorization for public sharing.

Additional specifications that operate alone and specifications that can coordinate in parallel, sequential and nested multi-specification arrangements are contemplated. Even with any multi-specification arrangement, some specifications may only be deployed optionally such as where invoked use only occurs when certain conditions are met during the generation. Together, multiple specification arrangements deliver an overall multi-specification based AI generative objective. Moreover, although a child's storybook was used as an example of one configuration of the dual sub-segment specification 121, many other overall segmented AI generative objectives fit the same construct. For example, a book of images with associated poetry, generated newspaper comic strips, lyrics and sheet music, script and movie generation, image and music generation, and so on.

Randomization built within episodic patterns and content patterns provide for personalization as well as maintaining context segment to segment and across specification runs. Topology segment options provides for adaptation, cost control, privacy, security, resource availability and adaptation from the outset and during the carrying out of an overall generation objective. A plurality of topology options may be selected from at any point to generate a segment or sub-segment of content, and even change the overall segmentation flow to carry out or continue to carry out an overall AI generative objective.

It is important to note that during the generation of a current segment, influences from previous sub-segments and segments generated so far, as well as influences from other subsequently generated segments and subsegments (from a previous cyclical generation pathways), all stored with in the AI input influence 127, can be accessed and applied as selected topologies and sub-topologies specify. During the generation of each segment, different types of topologies can be employed, and objective segment patterns 133 for each of those segments are also provided. In some configurations, the segment pattern 133 is randomly created entirely or assembled using partial randomization of subcomponents. In addition, it is possible to have segment randomization as well as episode randomization by means of a single content & episode randomization functionality. The episodic patterns, whether including random elements or not, may consist of a single pattern applied across all segments, a single pattern applied to only the first segment, or involve a plurality of episodic patterns each assigned to one of the overall number of segments defined to service the overall objective. Patterns of all types may each have sub-patterns which correspond and influence each corresponding AI nodes within each sub-segment. For example, a three sub-segmented segment having three corresponding AI nodes could all be influenced by a single pattern with such single pattern having three sub-patterns tailored to influence each of the three AI nodes. One such sub-pattern might, for example, deliver an influencing image, another sub-pattern influences with text, and while the third influences with and an audio sub-pattern.

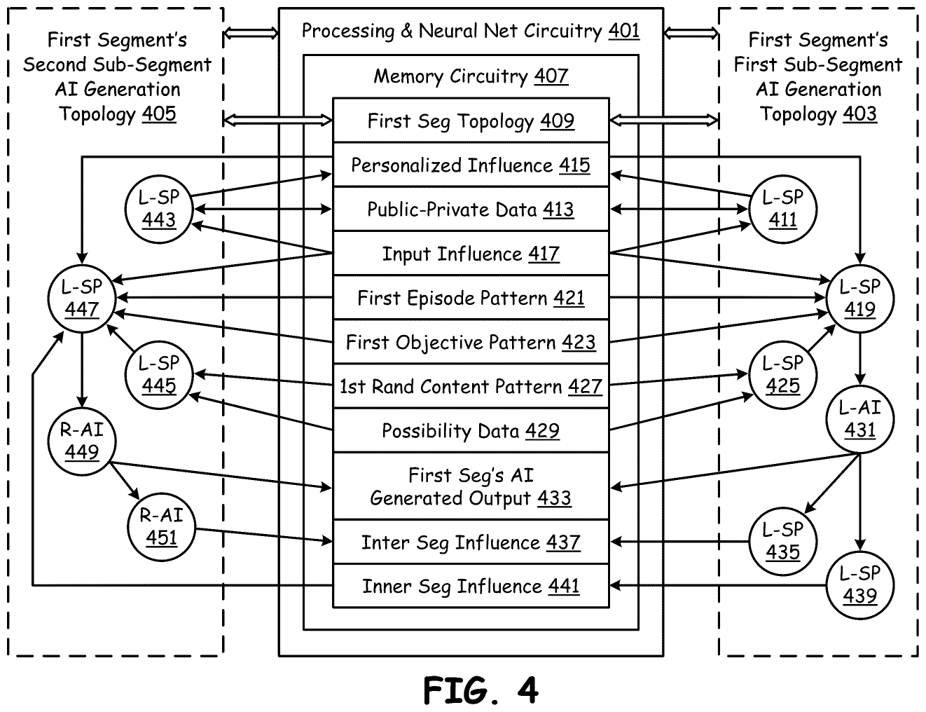

As mentioned, within the overall objective service specifications 113, there are a plurality of service group sets each of which correspond to a particular overall generation objective. Further details regarding one configuration of the dual sub-segment specification 121 can be further appreciated with reference to FIGS. 4, 5 and 6 below. And although only three specifications are illustrated within the overall objective services specifications 113, innumerable others are contemplated. For example, a single segment with a single sub-segment specification may be included which employs no patterns at all. Other possible specifications may find all types of patterns and perhaps even further classifications of patterns, and which only operates remotely pursuant to a single node topology. Tree structures within the overall objective service specifications 113 may also be constructed. For example, a high performing set of specifications which conduct sub-parts to other overall AI generative objectives might be added, e.g., a paragraph writing segment specification and an image generating specification might both receive separate specification entries due to the fact that they find reuse in many overall generation objectives to avoid repeating these specifications within an overall encompassing specifications. The encompassing specifications merely need to call out when appropriate one of the other listed specifications to assist in the overall generation objective underway.

Moreover, in some configurations, within any of the overall objective services specifications 113, topology segment definitions are provided for each segment and sub-segments, and these are adaptive as situations change. In some configurations, each a certain sub-segment reuses the same topology across all segments, while another sub-segment topology changes depending on which segment is being constructed and so on.

Users, remote events, input element signals, system status, environment status, location, and so on (hereinafter, “outside data”) may not only affect the underlying configuration for carrying out an upcoming overall AI segmented generation objective, outside data may also trigger the processing circuitry 105 to launch one of the overall objective services specifications 113. In addition, the outside data may also cause a change or abort an ongoing AI generation objective. For example, outside influence might trigger a change in topology or portions thereof, new influence addition or alter influence balancing wherein pattern types are added or removed and with influence adjustments made to those remaining. Such alterations may occur in the middle of a segment (or sub-segment) generation or between segments in what is referred to herein as segment breaks. Breaks may also occur between sub-segment generations within a given segment, or as referred to herein as sub-segment breaks. Breaks may comprise paused periods during with a user may assess generated output, or may only offer a location for carrying out outside influence induced change. Any changes happening immediately or within a break period may require abandoning some part or all of previous generation or merely just continue generations under the changed conditions.

Randomization may be carried out in many ways to populate a pattern with influence data. The options for randomness may be unlimited or fall within a limited set of possibilities. For example, an overall AI generative objective might only involve pitchers that played for the Chicago Cubs over the years, and an episodic random pattern might be limited to a list of such pitchers. In other words, the episodic random patterns might be populated by randomly choosing between such a limited list of pitchers and with one pitcher chosen, the episodic pattern resulting is then applied as to influence an overall episode of an overall segmented AI generation objective relating to that pitcher's past and present. Randomization may be used via any pattern as well, although it most often correlates best with episodic and content patterns. And such random patterns may be merely injected into one segment or one sub-segment, or across all sub-segments of all segments. An example might be where a first segment inject proves sufficient as inter segment influence 187 may carry forward the influence to other segments once injected. That is, applying an episode pattern to influence a first segment may be enough in some specifications such that the inter segment influence 187 carries the resultant influenced generation and its own exhibited context to be carried forward across subsequent segments.

Randomization may also be based on inherently random items to be populated, like date, time, location, age, gender, and so on. Those types of to-be-populated type entries may be added to a random pattern, and, when a specification is being used, those types of populations (those that are inherently variable) will be fixedly chosen and added to the pattern so that it can then be used to provide AI generation influence. One approach illustrated herein of the many possible approaches, involves using possibility data 161. In other words, randomness may come from possibilities or from an inherency. For example, a random pattern entry to be populated may call for today's date (inherently random), but, if today is a holiday, instead of or in addition to the date, the holiday name is also added. But that's not all. A tree structure may also require that if a holiday name is added that weather data (inherently random) must be added. Gathering the user's current location's weather data indicates rain so rain is added to the pattern as well. But because it is rain, a random roll to select either an umbrella or raincoat yields the latter and raincoat is also added to the pattern. Once such random tree structured population ends, the random pattern (which could be episodic or content related for example) gets applied by the processing circuitry 105 as defined by one of the overall objective services specifications 113.

In other words, population of random patterns involves both or either of inherent or possibility list selections, wherein logic may guide further sub-populations in tree-like processes until all population completes. In this way, even when repeating an overall generation objective by rerunning the same the overall objective services specifications 113, a user may expect to receive very different outcomes.

The proposed tree structured approach herein is but only one way it can be implemented. Alternate approaches to injecting randomness are contemplated, as those of ordinary skill in the art will realize. Other types of inherent randomness might be injected, for example, by basing population on processing internet search data which changes frequently and thus injects randomness. Another approach might be to use recent news articles, trending topics of the day, a user's own daily work product or device interactions to populate random patterns. Episodic random patterns may have very limited variation ranges by predefining sets of possibilities. For example, for a comedic murder mystery television series generation, an episodic random pattern might call for a murder-weapon to be populated from a fixed items list with odd items like a window air conditioner, microwave oven and a clown shoe, and wherein a random selection from that limited list is used to base an episode by delivering the episodic pattern to influence the screenplay generation of each episode.

In addition, objective segment patterns tend to correlate with user expected output of the overall segmented AI generation objectives. For example, to influence a book structure having an introduction segment, a preface segment, and chapter by chapter segments, objective patterns tailored for each such segment are applied along with appropriate segment topology configurations to influence underlying generative AI elements to deliver generated output in the formats the user expects to encounter. For example, a first segment topology and associated objective segment pattern to be used therewith, might merely define that output is to involve a page consisting of the book title, preface label, and double spaced chapter title names with associated page number reference. For the third segment topology and associated third objective pattern, a chapter one format might be added which differs from subsequent chapter formats but with sufficient chapter formatting constraints that the user experiences what is expected of a chapter as if it had been written by a human.

The plurality of segments of a desired content (such as a storybook with pictures or a movie) generated by the selected functional service groups (as part of the AI based generation) can be sequential in order, out of order, and even somewhat or entirely in parallel depending on the nature of the overall objective and corresponding need for inter-segment influence and correlation. For example, a storybook for an adult comprises multiple chapters and each chapter could comprise multiple segments or just one segment each, depending on the layout planned and a pattern selected for the generation. On the other hand, a storybook for a small child could comprise no chapters and only one segment (the single segment might then be considered to be a chapter by itself).

Within a segmented specification wherein a common sub-segment is used by all segments, per a particular specification (not shown), generation of a series of segments of content carried out by such sub-segment within each segment. If no inter-segment influence is required, all segments could be generated in parallel, but otherwise a sequential flow may be needed. Examples include but are not limited to generations of poetry books, image only coffee table books, musical audio feed, and so on). Similarly, the single segment with sub-segment specification 123 might support supports a single segment of output using one or many sub-segments with corresponding AI generations to carry out an overall AI generation objective. For example, as mentioned, the specification 123 might support for example generation of a brochure, flyer, MLS (multiple listing services), a political satire cartoon, quarterly reports and other business document, short stories, and nearly anything else that can may be sufficiently produced within a single segment configuration.

For example, in this scenario, a single segment pattern might suffice to generate a segment which essentially can be consumable/presentable content, such as a brief 30 second video for online distribution. But even then, a multi-segment approach may prove more desirable especially when each generated output of each underlying AI element may benefit from a segment break during which a user can inject modifying influence and/or a try-again command. Even within a brochure involving three text generations and one image generation, the process to generate such brochure may involve a four segment process, wherein a break is carried out by the processing circuitry 105 to allow user interaction or acceptance before moving on to the next segment. And therein, each segment would likely have differing topologies from the others to reach the overall AI generated objective, a high quality brochure. Alternatively, the brochure may be arranged with a single segment specification involving four sub-segments with similar results with breaks carried out between sub-segment generations to allow for user evaluations along the way. And lastly, it may be carried out in one complete topology where all of the sub-segment generations occur perhaps in sequences and/or in parallel then allowing the user an opportunity at the end to inject retry functionality across all or some of the underlying four AI generated outputs.

Regarding episodes, a single episode pattern may also be provided to set an overall objective factoring in a randomness or variability desired from the episode. The single episode pattern may set the style, duration, location, context and a theme, for a short video, an advertisement or a game, while the single segment pattern, if provided, might influence a storyline, a narrative and beginning and events (perhaps a bookend too) for the single segment. Various other elements may be provided in the single episode pattern and the single segment pattern. And as noted, a game can be constructed with traditional software programming code carried out by the processing circuitry 105, but it may also be constructed to include support from an overall segmented AI generation objective. Outside influence such as a mouse click can interrupt an ongoing segmented AI generation's topology flow to alter, replace, abort or pause, for example, such topology flow, or cause influence rebalancing, addition or removal associated therewith. Even a tree of segmented topology flow may change with outside influence during the game such that the game as a whole is actually driven by the AI generation.

As mentioned, the artificial intelligence input influence 127 makes it possible to generate content such as storybooks, movies and so on, within expected formats by a user and helps inject variety through randomness and personalization into the generated output. For example, during a segmented generation of a book wherein chapter being defined as a segment, a first generated chapter (i.e., first segment) influences the generation of the second chapter (i.e., second segment) and even a subsequent chapters (i.e., subsequent segments) yet to be generated. But for the entire first chapter of text to be used, support processing must be done to extract the most important aspects of the first chapter to be conveyed such that the context is maintained across chapters. Maintaining such context is carried out by delivering influence based on the support processed first chapter text based data (referred to herein as “inter-segment influence data”) toward the input of the second chapter text AI element with goals of affecting the associated generation.

Similarly, during the generation of a storybook, a currently generated segment may influence the next segment about to be generated and even a segment to be generated subsequently (or in the future). It should be noted that where inter-segment influence is not needed, the generation of various segments need not be sequential. In some configurations, only the first segment's generated output is used to influence numerous other subsequent segments, and other segments may not influence any other segment generations. Where a current segment is to be influenced by a plurality of previously generated segments, all such previous influence along with all other types of influence may be merged and balanced by the processing circuitry 105 as defined by the specified topology.

Similarly, inner-segment (within one segment, where one item or subsegment might influence another) influence is likely to be required when there are pluralities of sub-segments each based on AI elements that need to have some degree of correlation. Correlation can be achieved with inner-segment influence and by using an AI element or support processing which compares aspects of multiple AI generated output to render a correlation factor. If above a threshold, segment by segment flow continues. If not, cycling of generation may continue until an adequate correlation level is reached. In this manner, even correlation data output may be used as further influence to try to bring such generated outputs into acceptable correlation. And as before with inter-segment influence, if there is no inner-segment influence (i.e., no correlation needs between sub-segments' generations), sub-segment generations may operate in parallel. Otherwise, a sequential approach is needed.

Moreover, inner-segment influence can span between two sub-segments or any number of sub-segments in any chain, tree or “tangled bush” manner. They can also be cyclical in feedback style requiring reruns of sub-segments if necessary (e.g., when a correlation check by a discriminative AI fails). This cycling continue until correlation proves sufficient with a maximum cycling cap, or continue a fixed number of cycles before moving on.

Similarly, inter-segment influence can be used to tighten correlation between segments in the same ways as the inner-segment influence. Inter-segment influence can be applied in a single forward direction requiring no segment reruns. It can also span back to include inter-segment influence originating from multiple or even all previous segments. Cycling of multiple segment (or multiple sub-segments across multiple segments) reruns, until satisfactory correlation is reached or a fixed number of cycles is reached, just as mentioned above regarding inner-segment cycling, is supported in the present invention.

Generation of segments is influenced by an objective. So as can be appreciated, in configurations for particular overall generation objectives where tight correlation between segments (and between sub-segments within a segment) are not required, all sub-segments and segments, as the case may be, may be executed in parallel. However, operating in a segmented sequence may prove most viable in situations which permit confirmation or require user input to continue.

For example, a never ending storybook for a child guided by an overall generation objective (an objective such as providing mixed images and text on each page) may trigger a further segment production when receiving a child's next page swipe (e.g., when the child is viewing or reading the story page by page). Another page may also benefit from a child's facial expression and attention level to inject influence for the next page (segment) generation. Based on deciphering a child's reactions to the story generated up to a current point, wherein cameras and audio associated AI is received (via input circuitry of the input and output circuitry 109) might be used to identify as a child's feedback. A child's tearful face and sniffles might be used as influence data (herein referred to “outside influence”) to communicate something corresponding to a “don't cry” influence data that is injected into an ongoing segmented generation. Such outside influence may also trigger a storybook specification to distract the child from their troubles and cheer them up.

AI might also determine that the child is at a city's Central Park based on GPS (Global Positioning System) location data received via communication circuitry of the input and output circuitry 109. Based thereon, outside influence corresponding to “At Central Park” might be inject into a next segment generation (e.g., a next storybook page) which might include the park's name park image elements as a background in upcoming image generation.

Outside influence of any type may also trigger launch of one or more of the specifications within the overall objective services specifications 113, may terminate any such ongoing specification, or modify any aspect of an ongoing specification. For example, the generation of the current segment may be interrupted and partial segments may get created under differing topologies or influences, immediately upon receiving outside influence or when segment break points or sub-segment break points occur. In addition, a break points may be added not between sub-segments or segments. Instead break points might be added after a fixed generating period of time or after each time a number of segment generations have completed.

In one exemplary configuration, a child's storybook is desired to provide a number of pages with each page containing an image and associated text. Such image and text are also expected to correlate well with prior images and prior text to maintain a child's sense of continuity in the story. This is considered to be one of the “goals” to be achieved during generation of the storybook. As used herein, these goals are referred to herein as an “overall segmented AI generative objective.” Within such overall segmented AI generative objective, there are sub-segment generative objectives. One sub-segment generative objective would be to generate a next page's image that correlates with the next page's generated text and also with prior page's images. Another storybook sub-segment generative objective would be to generate text influenced by the prior page or pages of text.

From a broader perspective, in accordance with the present invention, there may be many more types or combined types of patterns beyond the six types of patterns indicated in the above embodiment. For example, all aspects of the random or fixed objective patterns (which mostly influence overall format and flow to meet user expected output generation), random and fixed content patterns (attempting to inject variability and personalize generation), and random and fixed episodic patterns (driving episode common context and episodic variability) can all be combined into one overall pattern. Such overall pattern and any of the AI input influence 127 sources can be combined and/or independently delivered to sub-segment AI elements within segments and across segments to assist in delivery of a quality AI generated output that has a best chance as satisfying or pleasing a user.

As noted above, it without randomization, both episodic and content patterns can still be created and applied. This can be done manually in a preconfigured way by a human or by generative AI with access, for example, to the user's private data with the public and private data 167. Pre-configuration of such patterns in fixed form can thereafter be applied every time an overall AI generated objective per specification is launched. In such cases, randomness may be trained into the underlying AI elements should such be desired. If there is a need to always use a watercolor style image generation, a fixed content pattern identifying watercolor as influence data can prove sufficient. It is possible to pre-populate a fixed content pattern set, the fixed influence can change with ever pattern in the set with each set member being associated with one or more segments. A first pattern in the set may influence with watercolor and the second pattern in the set may influence with pencil sketch. A first pattern applied to an image generating AI would deliver a watercolor and with the second generation being a pencil sketch.

Additionally, as mentioned patterns may also include sub-patterns where a first sub-pattern might be an image to be used to influence a first sub-segment's image generation, and with a second sub-pattern text that influences a second sub-segment's text generation. Also, if there are sub-segments, some sub-patterns may be absent. For example, for a two sub-segment topology within a single segment, only one or both sub-patterns may be employed for one or both of the two sub-segments. Moreover, both may receive sub-pattern influence for the current segment but neither receive a sub-pattern influence in the next segment.

As used here, the term “break” refers to the unplanned or planned period after a segment generation has completed (i.e., segment break) or sub-segment generation has completed (i.e., sub-segment break) and before the next generation begins. Breaks can happen as planned, e.g., where users are given an opportunity to provide input regarding a just generated output or for use in responding to outside influence. In an interactive segment by segment generation approach, a user via outside influence is given an opportunity at each segment break to accept a generation or to add further influence to future segment generation or to force a discard and regeneration with further influence added. Working in this way, a user can reach what they find to be a most acceptable overall generation output.

Planned segment breaks can be scheduled to occur between every segment or only occasionally. Unplanned segment breaks occur in response to a break trigger event that happens during any segment before the overall segmented generation objective has completed via outside influence. For example, a trigger break may originate from outside influence originating with any input circuitry, internal device status change, remote communications, or any other outside influence element. Unplanned segment breaks may cause a discard of an incomplete segment generation (in whole or in part) or hold until receiving further instructions or details via further outside influence. Outside influence may also be held until a scheduled break occurs and current segment or sub-segment AI generation finishes as defined within the topology. Which approach to use depends on the nature of the outside influence and duration remaining to complete a current segment generation.

Outside influence may be delivered directly from the input and output circuitry 109, but it may also be generated by remote or local portions of processing circuitry 105 involving status or current events or situations that arise relating thereto. In addition, outside influence can be generated by AI nodes, i.e., the neural network circuitry 103 and/or by the AI software models 163 (with or without support from the accelerator circuitry 107). Such AI nodes can receive input flow (input influence) from, for example, the input and output circuitry 109 and identify outside influence that would normally be unavailable, such as from direct signaling from the input and output circuitry 109. For example, in one configuration, a first AI node monitors a video feed from camera element associated with the input and output circuitry 109, while a second AI node similarly monitors and audio feed from a microphone element also associated with the input and output circuitry 109. From such feeds, the first and second AI nodes recognize communication associated with a user. For example, facial expressions and voiced text of importance cause either or both the first and second AI nodes to produce outside influence data. Such influence data may, as mentioned above, provide influence to an ongoing segmented generation, interrupt such generation, trigger a parallel specification based generation and so on. The video feed may also monitor background environment, attires, color and condition of clothes worn, eating habits, food being consumed and launch a topology in which it delivers outside influence not only launch one of the overall objective services specifications 113 but also to influence generation of a cartoon strip or character based on the outside influence generated by such video monitoring AI node. Such AI generated outside influence may also continue to apply changing outside influence as the video feed changes.

The overall objective services specifications 113 can be produced by third parties along with such third party trained generative AI and support processing nodes. A user may modify any such offering to create their own personalized version, including extra personalized training of copies of each AI node and may vary the topologies suggested or change influence weightings to address their own preferences. Other third parties may package their own overall objective services specification and prevent any modification thereof to ensure consistent quality and performance. For example, a news outlet, streaming media company, sitcom cast of characters, syndicated magazine, prize winning author, or famous musician, for example, might construct, train and test a complex segmented AI generating specification along with tuning all of the underlying influences and so on and license their use only without allowing derivatives to be prepared. Having the rights to create derivatives including even adding a user's personalization modifications may require additional fees or not be permitted. In other words, digital rights management may be applied to an entire third party specification.

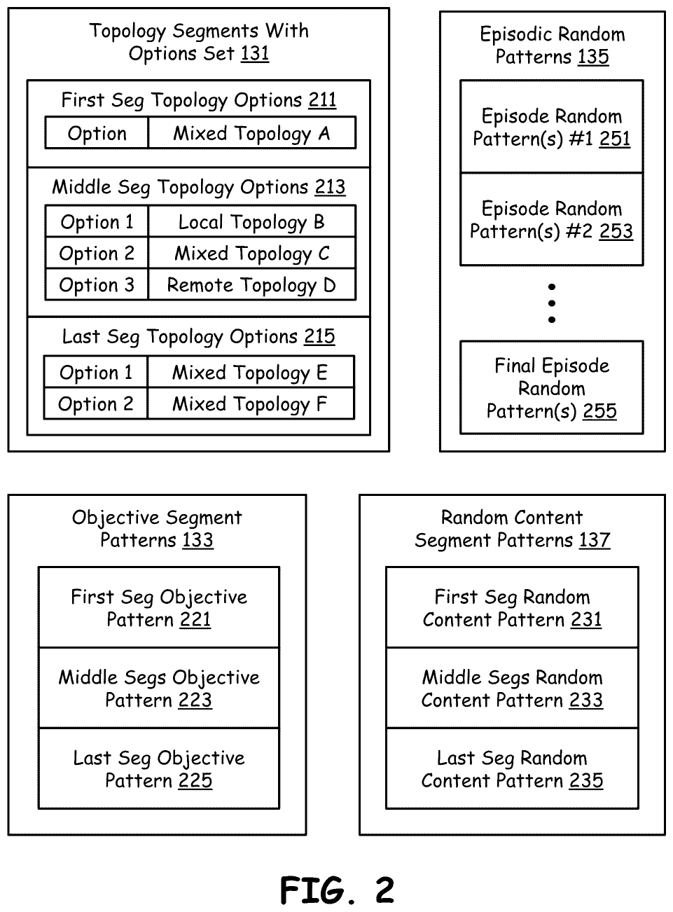

FIG. 2 is a schematic diagram illustrating several exemplary embodiments of a corresponding set of elements introduced in FIG. 1, wherein a segment sequence definition is set forth in accordance with various aspects of the present invention. Specifically, as illustrated within the dual sub-segment specification 121 (FIG. 1), exemplary embodiments of the topology segments with options set 131, episodic random patterns 135, objective segment patterns 133 and random content segment patterns 137 (originating in FIG. 1) are illustrated in this FIG. 2 with further details provided in accordance with this particular configuration and the present invention.

In particular, when attempting to service an overall AI generative objective associated with the dual sub-segment specification 121 (FIG. 1), the processing circuitry 105 (FIG. 1) uses three configurations—a first configuration for generating the first segment, a second configuration for generating all middle segments, and a third configuration to generate the last segment. The specifics regarding these three configurations can be found within each of the topology segments with options sets 131, objective segment patterns 133 and random content segment patterns 137. Within the topology segments with options sets 131, first segment topology options 211, middle segments topology options 213, and last segment topology options 215 can be found. Similarly, within the objective segment patterns 133, first segment objective pattern 221, middle segments objective pattern 223 and last segment objective pattern 225 are found. Also, first segment random content pattern 231, middle segments random content pattern 233, and last segment random content pattern 235 can be found within the random content segment patterns 137.

The processing circuitry 105 (FIG. 1) also selects one or a set of episode random patterns from the episodic random patterns 135 depending on the current episode of generation taking place. Episode random pattern(s) #1 251 are designed to apply influence to one or more segments of the first episode generation. Episode random pattern(s) #2 to influence the second episode generation and so on to reach a final episode where final episode random pattern(s) 255 are applied. Application of any of the episodic random patterns 135 may involve a single pattern applied to, for example, the first segment of a segmented episode generation, or may involve multiple patterns applied across all or some of the segments in such generation.

To generate a first segment, the processing circuitry 105 (FIG. 1) selects from the only option offered within the first segment topology options 211 a mixed topology A to carry out the generation, and applies thereto the first segment objective pattern 221, the first segment random content pattern 231, and the episode random pattern(s) #1 251 (assuming a first episode generation). For any number of middle segments, the processing circuitry 105 (FIG. 1) selects from three options one of a local topology B, mixed local and remote topology C and a fully remote topology D, and applies to all middle segment topologies the middle segments objective pattern 223 and the middle segments random content pattern 233. Instead of applying another of the episode random pattern(s) #1 251, the processing circuitry 105 (FIG. 1) relies on cross-segment influence to carry the first segment's episode influence forward through middle and the final segments. Once all generations of middle segments has completed, the processing circuitry 150 (FIG. 1) turns to the final segment generation using a selected option of either a mixed topology E or F, and applies influence thereto from the last segment objective pattern 225 and the first segment random content pattern 235.

To make choices between topology options offered within the topology segments with options set 131 (which may be made before an overall AI generation objective, during generation as each segment is encountered, or in response to outside influence requiring option reselection), the processing circuitry 105 takes into account any number of factors including but not limited to personalization, privacy, cost, digital rights, authorizations, resource availability, processing speed, loading, remote or local system status, user input, local or remote capability and quality, and any number of other outside influences. Initial option selections may change at any point over the course of carrying out an overall segmented AI generation objective. In addition, even a sub-segment generation characteristic might itself play part in causing an option reselection by the processing circuitry 105.

As illustrated, the first segment has only one option—a mixed topology A which involves both local and remote topology nodes. For the last segment, there are two options of topology specifications, a mixed topology E and a mixed topology F. Likewise, for generating the middle segments, there are three options of topology specifications available. These potential options are merely meant to be illustrative as many other options are available. Also note that there may be any number of sub-topologies that together comprise a segment's topology. These sub-topologies may also have options from which the processing circuitry 105 (FIG. 1) must choose and, if necessary, adapt between.

For example, in one configuration involving generation of a child's storybook with each segment being defined as a single page wherein a paragraph generating sub-segment and an image generating sub-segment deliver a page's content. To carry this out, the processing circuitry 105 (FIG. 1) carries out the paragraph generating sub-segment functionality in accordance with both a paragraph generation defining sub-topology and an image generation defining sub-topology, using a paragraph generation influencing sub-pattern from one of the objective segment patterns 133 and one of the random content segment patterns 137, and also using an image generation influencing sub-pattern from such one of the objective segment patterns 133 and from such one of the random content segment patterns 137.

During a segment-by-segment generation of content, e.g., cartoon, comic strip, storybook, etc., based on the topology segments with option set 131, influence is also applied beyond patterns. For example, during a generation of a current segment, influences from previous segment generations can be applied, as well as influences from other subsequent segments in a regenerative feedback manner or cyclical, multi-pass operational scenario. As used herein, such influence is referred to as inter-segment influence. Other influence may also similarly arise between sub-segments within a single segment which may flow only in a forward sequential direction or through cyclical regenerations as a topology specification so defines. Such influence is referred to herein as inner-segment influence. And yet other influence, referred to as outside influence, may originate from any other source outside of the normal specified topology's nodal construct as mentioned previously.

During the generation of each segment, different types of topologies may also be employed, and objective segment patterns 133 or random content patterns 137 may be changed or influence balanced on a segment by segment basis and even in response to outside influence or topology adaptations or replacements. In some configurations, the objective segment pattern 133 is randomly created or assembled in advance using partial randomization based on prior overall AI or human generated outputs, such as a collection of most highly rated novels. In addition, in some configurations, the processing circuitry 105 (FIG. 1) populates a random version of the object segment pattern for each segment or for only some segments such as the first segment for use in carrying out such segment(s) topology objectives.

Moreover, although only one option set for the objective segment patterns 133, the random content segment patterns 137 and the episodic random patterns 135 are shown, it is contemplated that, like the topology segments, such patterns can also have options. In this way, for example, higher or lower levels of influence or more or less randomization may be possible for each particular pattern type through selections by the processing circuitry 105. Such selections may be to attempt to tailor an upcoming overall AI generation objective in a way that tailors the generated output into a form more likely to please a first user or user type, and result in other selections of optional patterns to best service a second user or user type. In addition, such optional selections may be made to assist in merged balancing of influence or to reduce associated resource usage. For example, to remove randomization processing due to a local processing limitation or cost factor associated therewith.

In the generation of episodic content generation, a great deal of context must often be maintained across episodes. Of course, much of this context can be made part of episodic patterns such as might be found within each of the episodic random patterns 135. Some of this context can also be carried within the objective segment patterns 133 such as general episode format flow, e.g., a final segment revelation of a criminal within each mystery episode. Some other episodic context may also find a place within the random content segment patterns 137, e.g., a final chapter random weapon selected from a set of an umbrella and fisticuffs, both hallmarks of a protagonist that is carried across all episodes. To maintain main characters across episodes, the episodic random patterns 135 with fixed protagonist and sidekick might be added therein, along with their descriptions and unique behaviors. Such characters and behaviors might also or alternatively be integrated in whole or in part into any or all of the random content segment patterns 137. In addition, the behavior and dialogues of the main characters do not vary much across episodes, and this aspect is supported by the episode pattern set 133.

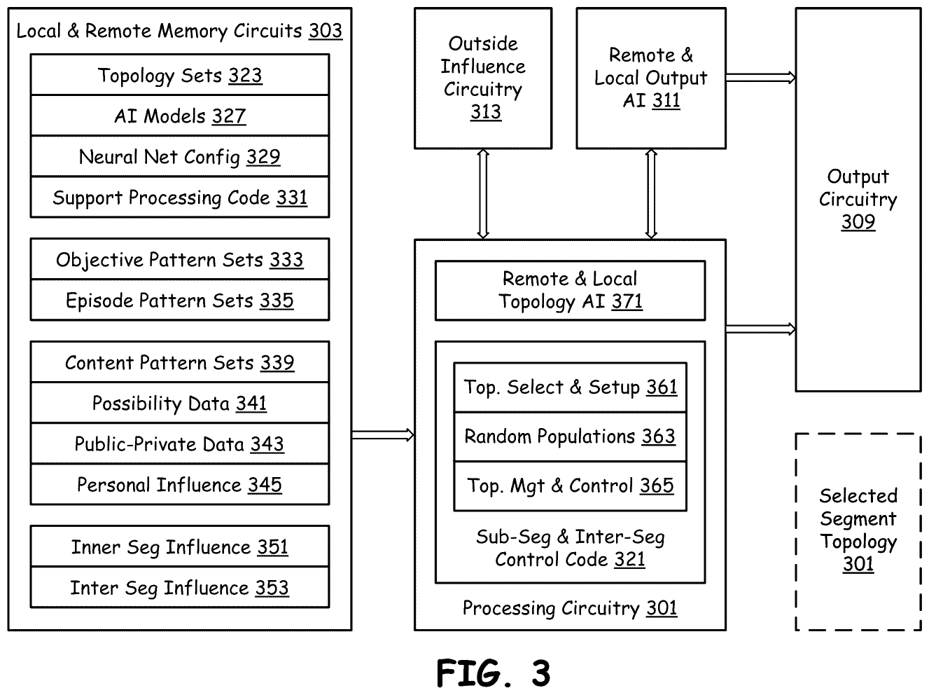

FIG. 3 is a schematic block diagram illustrating exemplary circuitry configured to conduct artificial intelligence generation on a segment by segment basis and guided by influence from a variety of exemplary sources, in accordance with yet other embodiments of the present invention. In particular, memory circuits 303 and processing circuitry 301, both being distributed across one or many local & remote systems, interact to carry out selected segment topologies 301 to service selected overall segmented AI generation objectives. Associated therewith, the processing circuitry 301 delivers generated output to the output circuitry 309 either directly or via remote and/or local output AI 311, i.e., AI communicative coupled to the output circuitry 309 not part of the defined topology that can comprise neural network circuitry with a configuration selected from the neural network configuration data 329 or comprise ones of the AI software models 327 with or without acceleration support from the processing circuitry 301. The processing circuitry also responds as directed to outside influence data from outside influence circuitry 313 which may also be distributed across any remote and local systems, e.g., from cloud servers to user devices and all systems therebetween or associated therewith.

To carry out a segmented AI generation objective, the processing circuitry 301 retrieves as needed various storage such as topology sets 323, AI software models 327, neural network configurations 329, support processing code 331, objective pattern sets 333, episode pattern sets 335, content pattern sets 339, possibility data 341, public and private data 343, personal influence 345, inter-segment influence 351 and intersegment influence 353. The processing circuitry 301 utilizes such various storage in direction both sub-segment and inter-segment processing via control processing program code 321. Therein, for example, the processing circuitry 301 carries out topology selection and setup 361, conducts random pattern populations 363, and manages ongoing topology flow 365 across all segments and sub-segments to complete the overall generation objective. In addition, remote and local topology AI 371, i.e., AI used to carry out some portion of Topology needed, can be carried out via neural network circuitry pursuant to the neural network configuration data 329, or by using the AI software models 327 with or without acceleration support from the processing circuitry 301.

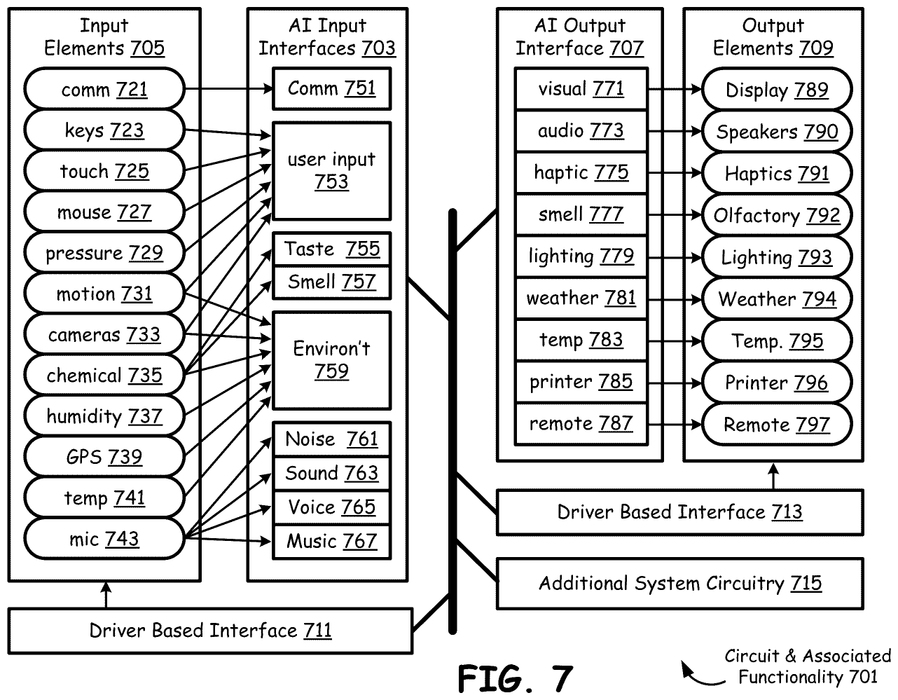

The selected topology for a given segment from the topology sets 323 may indicate communicative coupling with only a limited portion of the outside influence circuitry 313, and even then, for those with communicative coupling, the processing circuitry 301 may be respond in limited and controlled was as directed for carrying out each particular overall generation objective. The processing circuitry 301 may also deliver data to influence the outside influence data produced. The outside influence circuitry 313 may operate pursuant to typical program code to produce outside influence data, but it may also utilize AI elements in the production of the outside influence data. The processing circuitry 301 may also constrain the impact of the outside influence data as an assessment of the progress and adaptability options currently available may justify. Further details regarding outside influence may be found herein and with a particular focus with reference to FIG. 7.

As specified, the processing circuitry 301 retrieves appropriate ones of the objective pattern sets 333, content pattern sets 339 and episode pattern sets 335 as well as populates any random elements in such patterns from the possibility data 341 to carry out segment by segment, and sub-segment by sub-segment, generations. Population in the embodiment involving the employment of the possibility data 341. The possibility data 341 can be created on the fly, prepared in advance and used and reused, or downloaded from other users or third party vendors. For example, population data may be generated on the fly based on outside influence. For example, a child's calendar sends outside influence indicating that tomorrow is the child's birthday. The search of private data from the public and private data 343 reveals that the child desires a present of either a train, a ball, or marbles. In response, the processing circuitry 301 randomly populates from the list of train, ball and marbles and then uses the populated pattern along with “birthday wishes tomorrow” add in to influence the overall AI generation objective like generating a birthday storybook with the train randomly inserted as the present at the end.

Once stored within the memory circuits 303, the possibility data 341 allows for population of random elements of any of the objective pattern sets 333, episode pattern sets 335, and content pattern sets 339, by following a certain format which may vary depending on the configuration and possibility data 341. Some random populations can involve one variable for one random roll or working one by one down a fixed list of possibility data. And possibility data need not merely be textual. An image for use in a book of poetry as a backdrop to each poem on each page may carry a blank area in the center for text and a perimeter of image noise that such image input will result in a generation of an image with a particular high resolution and high quality perimeter but still with the center blank for generated poem text insertion. Such noisy image input can be included as part of any pattern. Any type of data may also be used as pattern influence data such as any type of data that is anything from machine readable formats to anything human experience can appreciate such as sensory type data.

For example, in a novel generation objective, the processing circuitry 301 in one configuration might populate a random element within a pattern such as [antagonists-profession] from possibility data 341 which could be a list of twenty professions like doctor, dentist, carpenter, politician and so on. To apply the pattern as influence, the processing circuitry 301 first replaces the random element [antagonist-profession] with one of the twenty professions listed within the possibility data 341. Selection might be a round robin approach, for example, for an episodic pattern, or a mere random selection, for example, for a content pattern.

Possibility data 341 might also be configured in nested arrangements such as if “dentist” is populated, then another random element emerges such as [type of dental practice] which requires another population chosen from the group cosmetic dentistry and oral surgeon. This nesting or tree structure may continue as first levels of random element selections lead to second and so on further levels of needed population. Other possible approaches depending on the configuration may involve much more complex random elements. For example, [storyline] may be selected from a dozen very different and detailed, near paragraph long text data intended to apply significant influence to constrain the overall generation objective.

Sub-segment to sub-segment and correspondingly segment to segment flow to carry out an overall segmented AI generation objective can take many forms. Some overall generation objectives will involve same segment generation topologies reused over and again until all segments have completed. Other overall generation objectives may define topologies in which every segment or subsets of segments are generated in different ways and even with differing numbers of sub-segments per segment or group of segments. Further complexity is added with overall generation objectives that require adaptation in segment by segment ways to reach an endpoint or continue until the objective is terminated. Such adaptation may involve choosing each segment and even sub-segment topology from many options as each generation progresses and based on either or both of generation data and outside influence. Topology selections and flow from the topology sets 323 may then be viewed as a tree structured option pathway. Choosing one of many options for a first segment (or sub-segment) generation may lead to another set of segment (or sub-segment topology) options that would not be available had the first segment option been chosen. This can be viewed as a tree or tangled bush structure that may loop around and around in different pathways as each segment of generation leads to the next.

Overall topology specification options for handling each segment and corresponding sub-segments are retrieved all at once or in sub-segment by sub-segment or segment by segment basis for use by the topology selection and setup functionality 361 pursuant to the control code 321 of the processing circuitry 301. Such retrieval may also be in option groups only for a pending sub-segment and be used for both initial selection and held at the ready for topology option switchovers post selection.

As described earlier, each pattern is applied as called for by each topology (or sub-topology) in use. For example, an overall generation objective to create a current topic of interest article automatically based on top trending search topics from an internet search engine might involve two AI elements corresponding to two sub-segments with two corresponding topologies. The first sub-topology uses a support processing element to retrieve each day's top trending search topic lists. From this list a random population into a pattern is applied, selecting one of the top 50 topics at random. Such populated pattern is then delivered to the memory circuits 303 for storage and to a first AI element that generates an attention grabbing title based thereon. This title is also stored within the memory circuits 303. The processing circuitry 301 then selects and invokes a second sub-topology for the second sub-segment generation. Here, the processing circuitry 303 retrieves the stored pattern and uses it to search the internet and the local and public data 343 which support processing then converts the search results into a second pattern that is delivered to a second AI within the second sub-segment that generates two paragraphs of text regarding the topic. Together the title generation and the paragraphs of text are delivered to the output circuitry 309 which may, for example, deliver a pop-up combination for user perusal. Alternatively, this single segment of processing may continue for a fixed number of article generations for combination into an online newspaper for sharing and dissemination to other users, running repeatedly to deliver fresh daily regenerations.

Note that a pause or break can be inserted or be available for insertion between segments and sub-segments to accommodate any type of outside influence such user input, an input circuitry related event, or system status, to name but a few types of outside influence. That is, outside influence may cause a break to occur which normally won't exist. Or, breaks can be intentionally added between every segment or sub-segment or after a certain group of segments within the overall segment total completes. Instead of forcing a pause, outside influence may from the outside influence circuitry 313 may also fully derail the overall AI generative objective. Outside influence may alternatively inject influence into an ongoing segment generation process.

Segment and sub-segment breaks whether by plan or by outside influence trigger, provide opportunities to reevaluate any part of or all of an overall AI generative objective. For example, a user's input request during a section break may cause the processing circuitry 301 to abandon previous parts or all prior generation, change weighting of influence, add additional influence, and change one or more segment or sub-segment topology selections for past and/or future segment production to complete the overall AI generation process. A loss of internet connectivity related outside influence too may cause remote topology nodes to be relocated to local counterparts to continue segment generation, and so on. Outside influence delivered via the outside influence circuitry 313 may also trigger a launch of an entirely new topology flow (i.e., another overall segmented AI generation objective) in parallel or to replace that currently being generated. Based on some types of outside influence, for example, injection of new data or images or characters into a storyline might occur, a transition in the storyline for stories (storybook for example) or video (movies for example) being generated, a change in the quality of images created, a change in the tone of the narrative, a modification to an upcoming twist in the story line, etc. Such outside influence may also trigger reruns or full stop, or cause a change in a tree/tangled bush type topology, or cause even single element swap outs as well.

Segment flow can be tree type as described herein, where one node in the tree, when encountered expands into a new set (ordered or otherwise) of additional deliverables (nodes), which in turn get replaced by a more granular set of media or content, such as additional detailed paragraphs for a page (segment) or additional sections of a scene of a video segment being created. The tree or tangled bush type topology flow can be either predefined structure or more dynamic being enhanced at run time with addition nodes at various levels upon transit. Of course, a tangled bush type of segment flow might define a more complex flow control to be carried out by the processing circuitry 301 wherein a current segment generation would be influencing (for example) not only a future segment (such as a subsequent segment), in addition to which the generation of the future segment could potentially cause a change or otherwise influence not only the current segment but also a previous segment(s). This implies that a segment might surely get modified or recreated due to the influence and operation of a subsequent segment, etc. This might be done to increase correlation required to best serve a particular overall AI generative objective.

Although the flow control through a segmented generation may be defined with an overall service specification, in some configurations, segment to segment flow is driven by a user as segments are evaluated. For example, after reviewing a generated storybook page conducted while the processing circuitry 301 stands by during this segment break, a child may interact to turn the page. This is detected as outside influence and instead of immediately generating and delivering the next page, the processing circuitry 301 delivers a pop up message to the child conveying a message, would you like the story to be happier, scarier, use more images, have more text, and so on. Additionally, or alternatively, a child could be asked if they like the story so far. If not, a full regeneration may be offered. In response to whatever the child indicates via the outside influence circuitry 313, the ongoing generation may be altered. Such a popup interaction and associated influence adaptation may occur at every section (page) break or only occasionally to avoid being bothersome. Such outside influence may cause the processing circuitry 301 to alter the current generation in all or any of the ways previously mentioned, including but not limited to influence injections, topology modifications, and drive tree or tangled bush redirected pathways.

Thus, for example, a storybook for a child is expected to provide a number of pages with each page containing an image and associated text. Such image and text is also expected to correlate well with prior images and prior text to maintain a child's sense of continuity. As used herein, such goals and, in general, the objective of generating a correlating contextually consistent storybook that a child of a certain age might expect and appreciate is referred to herein as but one example of an “overall generation objective.” Within such overall generation objective, there are also segment generation objectives and sub-segment generation objectives. For example, one sub-segment's generative objective might be to produce a next page's image with the same style of the prior page's image that correlates closely with the next page's generated text without losing prior image context.

Similarly, for example, an overall generation objective for an automated news article generation might be to have an attention grabbing title (via a first sub-segment generative objective with a title writing first AI) and two paragraph body of text regarding a trending internet search (via a second sub-segment generative objective with a search topic writing second AI). These objectives can be for just a single writing event (for a single title and body), or for populating an entire magazine. This can be done with or without inter-segment influence (to keep to a theme) or merely use the inner-segment influence to keep the title and body of text in tight correlation.

Further details for how the processing circuitry 301 interacts in a particular configuration carried out by the infrastructure of FIG. 3 can be found with reference to the following FIG. 4, which is but one possible embodiment involving a dual sub-segment process for delivering a multi-segment generation of output wherein sub-topologies change across segments.

FIG. 4 is a combined schematic and functional diagram illustrating a processing and neural net circuitry 401 that employs memory circuitry 407 storage to carry out a first segment generation within a plurality of segment generations that service an overall segmented AI generation objective. For the first segment, a first sub-segment generation topology 403 and second sub-segment generation topology 405 work together in sequence so that a correlation between the underlying two AI generations can be maintained via inner-segment influence. Both the first sub-segment generation topology 403 and second sub-segment generation topology 405 are functional representations of topology processing carried out by the processing and neural net circuitry 401 in accordance with the memory circuitry 407 storage.

Basically, for the first sub-segment generation, the processing and neural net circuitry 401 accesses a first segment topology 409 to extract a first sub-segment topology specification from which the functionality of the first sub-segment generation topology 403 can be performed as illustrated. Therein, a local support processing node 411 (carried out by the processing & neural net circuitry 401 as with all other topology nodes) uses input influence 417 to perform a search of public and private data 413 to generate and store personal influence 415. Another local support processing node 425 populates a first random content pattern 427 using possibility data 429. This populated pattern output is then delivered along with the personal influence 415, the input influence 417, first episode pattern 421 and first objective pattern 423 into an influence balanced merging support processing node 419 (also performed locally) to generate a combined influence output that is delivered to a local AI node 431 that delivers a first sub-segment AI generation to the memory circuitry 407 for storage as a first part of first segment's AI generated output 433. In addition, the generated output is delivered to another support processing node, local support processing node 435, to reconfigure and convert the generated output for storage as inter-segment influence 437. Similarly, the generated output from the local AI node 431 is also delivered to another processing node, a local processing node 439, which reconfigures and converts the generated output for storage as inner-segment influence 441. Thereafter, since the processing and neural net circuitry 401 has completed the first sub-segment AI generation topology 403, it turns attention to the second sub-segment AI generation topology 405. Also, for shorthand purposes, terms such as L-SP refer to a “local support processing node,” while R-AI, for example, refers to a “remote artificial intelligence node” as illustrated.

Therein, a local support processor 443 uses input influence data 417 in much the same way as the local support processor 411. But because the AI node of the first sub-segment and that of the second sub-segment are different and serve different purposes, the search of the public and private data and resulting personalized influence 415 are also different. For example, if the first sub-segment AI node is influenced by a particular text construct, the second sub-segment AI node may use an entirely different influence data including even being of a different data type such as image data depending on the actual overall generative objective happens to be for a particular configuration.

Local support processing node 445 also populates at least a sub-pattern of the first random content pattern 427 (a portion that may too comprise an image versus text or other data type) using possibility data 429 to generate a populated (sub) pattern output that along with at least a portion of the personal influence 415, at least a portion of the input influence 417, at least a sub-pattern of the first episode pattern 421, at least a sub-pattern of the first objective pattern 423, and the inner segment influence 441 into an influence balanced merging support processing node 419 (also performed locally) to generate a combined influence output that is delivered to a remote AI node 449 that delivers the second sub-segment AI generation to the memory circuitry 407 for storage as a second part of the first segment's AI generated output 433. In addition, the second sub-segment generated output from remote AI node 449 is delivered to influence a remote AI 451 that generates inter-segment influence 137. At this point, the processing and neural net circuitry 401 completes the generation of the first segment of a plurality of segments that service an overall segmented AI generation objective.

More specifically, in one configuration involving an exemplary storybook generation, the processing and neural net circuitry 401 via the first sub-segment AI generation topology 403 delivers a first paragraph of text for use in a first page of a storybook, the page representing a segment. Similarly, the processing and neural net circuitry 401 via the second sub-segment AI generation topology 405 delivers a first image influenced by the first paragraph of text for combination with the first paragraph of text as the first page (first segment) of the storybook.

To carry this out, within the first sub-segment AI generation topology 403, the local AI node 431 receives first textual, combined influence data as input and, based thereon, delivers the first paragraph for use on the first page. Likewise, the remote AI 449 within the second sub-segment AI generation topology 405 receives second textual, combined influence data as input and, based thereon, delivers the first image for use on the first page. Such first and second influence though being quite different. For image generation, for example, image style, resolution, brush strokes, palette and so on may be textually defined and applied to remote AI 449. For text paragraph generation, although such combined influence may still be in textual form, the actual contents thereof may be substantially different such as including things such as word simplicity (to fit a child), storybook genre, rhyming and so on, and for application tailored to influence the local AI node 431. Alternatively, if the remote AI 449 was trained to react to image input, the combined output influence to be delivered to the remote AI node 431 may have been image oriented and not textual.

Of course, as can be seen, although somewhat similar, the first sub-segment AI generation topology 403 carried out by the processing and neural net circuitry 401 is different topologically and functionally from that of the second sub-segment AI generation topology 405. One difference being that the output of the local AI node 431 is used to influence the generation by the remote AI node 449 such that a certain degree of correlation between the two generations is maintained. For example, a rhyming paragraph about a boy and dog might then drive an image generation including the boy and dog.

Although as illustrated only two sub-segments service a single segment, many more sub-segments are contemplated to deliver any corresponding number of particular AI output generations needed for a given segment. Even a plurality of AI generative sub-segments arranged in possibly an N-dimensional layout to simultaneously or sequentially generate all of the sub-segment outputs needed for a particular segment could be deployed. Moreover, subsequent segments may be serviced with entirely different sub-segment topologies and differing numbers of sub-segment and associated AI generated elements. Such variations correspond of course to the overall segmented AI generation objective. For example, a first segment might generate a copyright and legal rights callout page using a single generative AI node, while an Index might use two AI nodes for the second segment. Thereafter, a chapter one of a novel might require a title generating AI and a chapter text generating AI, and so on. Different segment topologies for each segment objectives.

During operation, the processing and neural network circuitry 401 employs processing code and functions available in a memory circuitry 411 that also comprises a variety of different types of data including the first segment topology 409, public and private data 413, input influence 417, personalized influence 415, and so on. The processing circuitry and neural network circuitry 401 interacts with the memory circuitry 411 to set up in staged sub-segments the first segment generation.

For the child's storybook, input influence 417 may include the child's request “Tell me a story about a little princess.” Such a request being received as outside influence which is then configured for use in combination with varied other sources of influence to affect a storybook creation involving a princess. Other outside influences may source the input influence 417. For example, such outside influence may arise from sensors, location detectors, microphones, cameras, communication pathways, application software, and internal system events and status. For example, a night time and bedroom location detection type outside influence may introduce via the input influence 417 a trigger asking the child if they want a bedtime story or automatically trigger a storybook generation at least of the first segment (page). Or outside influence detecting that the child is dressed as a princess might respond by influencing via the input influence 417 a princess story.

The local support processing 411 may receive a child's simplistic input (originating as outside influence from an input element) and respond by using such input to retrieve from the public and private data 413 enhancing relevant/related influence data. For example, “Tell me a story about my pet,” a search can be made of private data to find the pet is a yellow Labrador puppy. The personalized influence 415 might then identify such details such that a more relevant storybook is generated. Similarly, for a requested princess story, public data identifying the name and a few facts associated with Cinderella may result in a personalized influence 415 that helps generate a new Cinderella type storybook. Such personalized influence 415, once generated, can stored and reused over time as seems appropriate to avoid regeneration.

In another configuration, the overall AI generation objective is to create a living electronic photo album, wherein anytime the album is opened and tailored for the particular viewer, the contents displayed changes and is automatically updated to the present day. To accomplish this, private data mainly buttressed by public data from the public and private data 413 stored in the memory circuitry 407 (which may comprise many sources of distributed storage within a user device or on any other device or system wherein data is accessible) is searched and processed by the local support processing node 411 to extract correlating data of all data types available relating to the album target, for example a grandson, and the grandfather viewer. This includes dates, times, location information, holidays, and so on extracted from public data sources as well. All of such information is arranged and stored as part of the possibility data 429. The local support processing node 411 also randomly chooses correlating groups of data for a present day's album perusal by the grandfather, where the grandfather identity as the viewer and the focal point being the grandson being conveyed from outside influence via the input influence 417 data.

The processing and neural net circuitry 401 then delivers the personalized influence 415 and the input influence 417 for merger by the local support processor 419 along with other influence data, such as the first objective pattern 423 that may indicate 4 images per page for example and location, font, font size, title length and so on to accommodate the grandfather's vision and expectations. Such tailoring for the grandfather may be carried out by random list selections associated with the first objective pattern 423 populated based on the grandfather viewership indications from the input influence 417.

Similar processing takes place via the local support processing 443 which collects image data from private photos and public photos of locations involved on certain days such as water park photos from other users available publicly along with photos taken by the grandfather of the grandson at the park. Only one photo taken by a third party of the grandfather and grandson is available. And all of the grandfather's photos may be of poor quality because of a smudge on the camera lens.

For a day at the waterpark album offering, selected based on a request from the grandfather for such album type as indicated by the input influence 417, a first page segment is configured to include four images generated from a combination of public and private images taken at the waterpark. For example, the remote AI node 449 may generate for the first page four images based on public wide angle waterpark images modified by generated additions of the grandfather and grandson holding hands in line to enter, where the details of the grandson and grandfather being extracted from other images. That is, private images of the grandfather and grandson and public images are extracted by the local support processing 443 using a search based on the grandfather's request for a waterpark album generation as indicated in the input influence 417. Such search taking place in both the private and public data 413. Selected ones of such images are then selected and stored within the personalized influence 415. Other influence image data may be delivered via the first objective pattern 423 which is an album page framework page skeleton having four blank slots to be filled with image data. This first objective pattern 423 and the personalized influence 415 may be delivered to influence the remote AI node 449 in its generation of four images into the overall album image page (segment). The local AI 431 receives the generated image page from the remote AI 449 via the inner segment influence 441 pathway (not shown) and adds thereto descriptive text related to each image.

Page two (segment two) might involve repair generated and enhanced images taken by the grandfather of only the grandson wherein the smudge effect has been removed. On page three, the grandfather has been inserted into other images with the grandson, generated from access to a variety of other images and image data and changed from a posing organization to appear as live action image captures. Credit card use indicates ice cream cones were purchased, so images with the grandfather and grandson eating such cones are generated on the next page. Pages continue with real photos, repaired photos, adapted photos, and fully generated photos, including generation of a photo of the grandfather and grandson looking over shoulder at the waterpark at the exit. A color code at the corner of each photo indicates the degree and type of image AI procedures were employed so that the viewer can understand how much of the album was real and what is enhanced.

To carry out these types of AI generations, several modifications to the illustrated sub-topologies might have to be made, such as changing the order of sub-segment sequencing as well as redirecting influence from text generation influencing image generation to the opposite-image generation influencing text generation. Moreover, should the grandfather want to view this exact storybook again, it can be saved in a conventional format for later access. Otherwise, full regenerations each time provide for endless revisits with yet other chances to spur memories. Other factors may also drive image generations as well, beyond credit card usage. For example, the grandfather may desire all other people to be removed from the images to avoid distractions. He may request a cloudless sky, or a trimmer physique, framing change, other person add in, and so on, and a newly generated album or even a substitute image on one of the pages may automatically replace the old on that page or throughout the album.

In some other configuration, user input is also selectively used as a search string to generate categories of influence and processed along with public-private data 413 with the results are stored as the personalized influence 415. Later it can be merged with different influences, as necessary, with balancing of influences. The input influence 417 is also reusable when saved, and can be factored to incorporate a little more of the user's desire through such influence reuse. For example, to heighten its influence impact beyond the personalized influence 415, the input influence 417 is also delivered to the local support processing node 419, where it is merged for example with the personalized influence 415, a first episode pattern 421 (that attempts to constrain segment generation to episodic context and possibly assert a bit of randomness) and a first objective pattern 423 that influences segment formatting.

Segmented generative AI as described herein also provides for the specification of an overall goal, the reasons why the generation occurs, and how such goal (or objective) shall be accomplished. That is, to service an overall AI generative objective, there are often may ways to accomplish the objective. Some ways may prove better for some users and other ways for others. And different ways may also depend on underlying influence itself. The processing and neural net circuitry 407 must take these factors into account in choosing an overall topology as well as choosing optional underlying topology portions thereof.

The local support processing 419 conducts balancing of all the influence sources such that no inappropriate influence weighting of one source over others that ends up overwhelming the generation by the local AI node 431. Note that the first episode pattern 421 may comprise a single pattern to be applied to only the first segment or may consist of a series of patterns for each segment of each series should the episodic influence of the overall AI generation objective so benefit. For example, a first episode's first and only pattern to be applied to the first segment generation might only include one element of influence data such as “mystery at a ballpark.” For a second episode, the first and only pattern might be “oceanfront death” and so on. Both of these fixed text influence data, may also comprise a random selection between the two or more of such influence types via use of the possibility data 429 and lists of these pattern elements that may be randomly selected for inclusion.

Similarly, a first segment content pattern may call for “politician's suicide” while the second segment content pattern might include “evidence of murder and coverup” and so on such that a story generation may achieve a very specific guided generation. Likewise, a first episode pattern 421 might include influence data corresponding to text “mystery issue,” the first objective pattern 423 including “introduce issue” and the first random content pattern 427 introducing “Chicago Cubs baseball player suspect.” In other words, all patterns may be designed to coordinate an overall influence flow and overall effect. For segment two, for example, “baseball player innocent” and, in segment three, and “player's wife having an affair” and so on. With detailed patterns, overall AI generation objectives can be strongly influenced and guided or, with minimal pattern or other influence, may leave most of the generation variability and constraints to the underlying AI nodes themselves which they may be specifically trained to do.

Such influence injections may be created and shared by a third party, or may be created by the user. They may also be AI generated based on an analysis of a user's personal favorite prior human or AI generated overall objectives output, such as liked movies, images or novels. In one exemplary configuration, to generate a novel, for example, a first objective pattern for chapter 1 would be modeled after a reader's favorite books involving Sherlock Holmes. Objective patterns, episodic patterns and even random content patterns could be created and used to service the overall AI segmented generation objectives and yield new Sherlock Holmes novels that follow the writing style and chapter by chapter sequence of Conan Doyle.

Therein, it might be determined (by human or AI) that an objective pattern would include influence regarding each chapter size, number of chapters (segments), and expected chapter to chapter flow. Some of this information could also end up being placed in random content patterns as well as nestled within episodic pattern sets.

Much pattern influence injected for example in a first segment need not be repeated across other segments, although it may be to intensify the influence. This lack of need may be supported by inter-segment influence instead. A bloody dagger pattern text that finds its way into generated first segment text, will likely be carried forward through such inter-segment influence for example. Another example would be for maintenance of an episodic protagonist and antagonist across each episode only needing to be injected in the first segment and thereafter relying on an adequately trained generative AI to keep track internally and through inter-segment influence. Alternatively, patterns identifying the antagonist and protagonist might be repeated for each segment to influence appropriate AI node generation based thereon.

Random population of any type of pattern as mentioned herein can also be applied. For example, the possibility data 429 available may provide options lights, labels, backdrop, location, murder-weapon, family-names, etc., all arranged into lists under random element names which can be added to any pattern. Thereafter, to populate a random element name, a selection is merely made from selections from the underlying lists. Such lists may also be arranged in tree structures. For example, populating a family-names may not only choose a random family member name but also require a sub-population selected from a secondary underlying list containing a plurality of description influence for that family member such as a grouchy, stern or happy and when younger or older and so on. In effect, many populations from private data may be viewed as personalization, but personalization may also arise from public sources as well with the list inclusions being based on a user's (or similar user's) realm of interest. Possibility data may also be much more generic and be applicable to everyone or groups of people of which the user is a member.

The possibility data 429 can be downloaded from the internet, when it is created by some third party, and arranged into random-tag based tree structures. Such random tags can then be selected manually or automatically generated into random patterns for later population from the content options within the tree structures. Such population by selecting options might involve for example round robin or other some random selection approach.

In one configuration, for example, a population of a random element within a pattern labelled “pet” branches to “dog,” “cat,” “mouse,” and “pig.” If a random selection chooses a “dog” branch, the next branching leads to several dog breeds including “Labrador” which if chosen selects from another and final branch to choose “happy” or “sleepy.” Thus, as may be appreciated, the single random element such as “pet” can lead to a chain of populations related specifically to the reach random step in the other pathway through a tree structure and with many terms therein being combined as population data into the final populated pattern to be used as influence.

Such random elements can be identified using bracketing to surround a term that the processing and neural net circuitry 401 responds to be seeking population data in replacement thereof.

Tree structures for population may be updated continuously or daily for example. For example, a bracketed term such as “[news]” might have an underlying tree structure adjusted each morning in sub-categories and sub-sub-categories and so on and readied for random selection for influencing AI generation that day. Updates to a tree structure may also be made upon request when preparing for use within a pattern. For example, before populating the bracketed term “[news]” encountered in a random pattern, the processing and neural net circuitry 401 seeks an update of the entire news bracket tree. Once the update is received, a first sub-category in the updated tree (i.e., the first branching point) might involve a random selection from a sub-bracket [sports-news] from other types of news brackets. From the [sports-news] bracket, another a random selection is carried out for “[tennis]” from other listed types of bracketed sports, and finally text influence relating to one randomly selected set of tennis stories is selected and associated influence text is retrieved and added to finalize population of a pattern that is then used by generative AI to service an overall objective of delivering a pop-up news blurb to grab a user's quick glancing attention. Such tree structure bracketed terms may be added permanently, for one time use, or for use during a particular time window. Thereafter, such bracketed term or underlying tree structure can be replaced or removed entirely.

In response to a child's input request (via the input influence 417) such as “tell me a story about, you know, a prince that's a vampire or something,” the processing and neural net circuitry 401 in accordance with the local support processing node 411 conduct a search of private data 413 to find for example a user's folders on a local hard drive with favorite vampire characters in cartoons. From this search, a vampire's name might be extracted and a characteristic of slurping strawberry sauce through straw teeth the vampire's feeding habit. From such personal data, personalized influence 415 may be added, and, also based thereon, a random tree structure could be created and added to possibility data 429 where cartoon antagonists are all listed and described for random selection for AI writing generation for the currently requested or any future requested storybook. Other random tree elements might also be added, such as those that might select to be more or less scary, add in different sidekicks, and so on with selection for pattern population through some form of random choice.

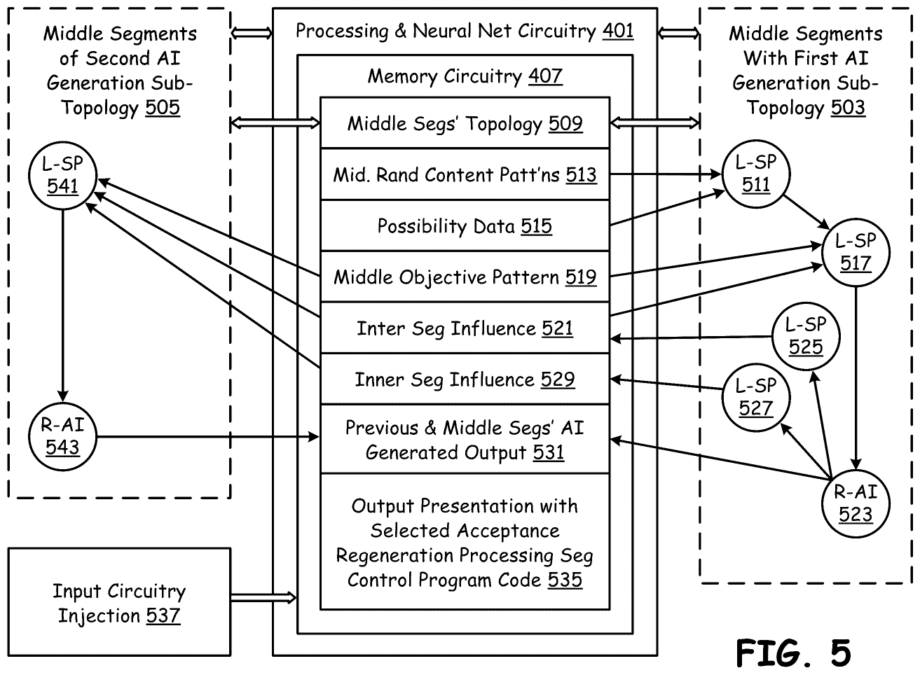

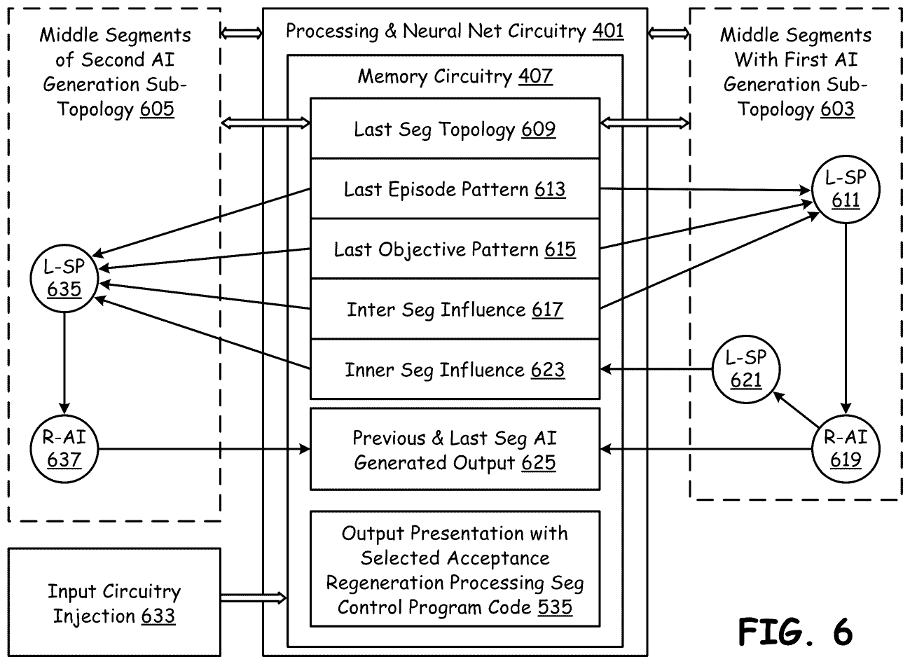

FIG. 5 is also a combined schematic and functional diagram illustrating middle section topology based generations by remote and local circuitry to process a plurality of middle segments after the first segment generation has completed as described with reference to FIG. 4. As with the previous first segment generation (FIG. 4), the processing and neural net circuitry 401 directs generation of all middle segments of the overall segmented AI generation objective in this current configuration. FIG. 6 which follows will complete the segmented flow wherein the last segment is generated. This overall segmented configuration illustrates that not every segment requires and new topology, and that any number sub-topologies need not be the same within or across segments. The logic of segmentation and associated topology is what is attempted to best serve a particular overall AI generation objective under current circumstances.

As circumstances change (i.e., changes in outside influence), parts of one or more segments of sub-topologies to multiple segment topology changes and to even entire topology specification may be altered or replaced. Moreover, the format flow of an overall segmented topology like that illustrated in FIGS. 4-6 are made to attempt to best optimize overall service and output. For example, a first segment of most segment flow configurations that is strongly based in inter segment influence will likely need to have a great deal of influence types weighing in on the first segment to set the stage for future segment generation. This eliminates much of the complexity that might be found in middle segment topologies who may receive echoes of the first segment influence through inter-segment influence. The final segment often also carries additional and different burdens to complete the overall generation service. In such cases, there will be a different topology need for the final segment. Such is the configuration illustrated across FIGS. 4-6.

Specifically, the processing and neural net circuitry 401 responds to a service request via outside influence such as a user request by first identifying the first topology and generating the first segment as illustrated in FIG. 4. Once completed, the processing and neural net circuitry 401 selects a topology configuration to be applied to all middle segments from the middle segments' topology 509 stored in memory circuitry 407. The topology selected, often from many available options for generating the middle segments, in the present selected configuration includes two sub-topologies: a first AI generation sub-topology 503 and a second AI generation topology 505. These sub-topologies are designed to operate in sequence such that inner segment influence 529 can be passed therebetween for correlative purposed.

To begin any middle segment generation, the processing and neural net circuitry 401 operates pursuant to the functionality illustrated by the first AI generation sub-topology 503 wherein a first type of data, such as a text paragraph for a storybook configuration, for a middle segment (i.e., middle page of the storybook) is generated. A local support processing node 511 populates a particular one of middle random content patterns 513 to be applied to a particular one of the middle segments. That is, for the first middle segment (page two of a storybook), the first of the middle random content patterns 513 is extracted and populated from possibility data. The local support processing node 511 then delivers the populated content pattern to a support processing node 517 that merges therewith with influence balancing a selected objective pattern of middle objective patterns 519 and retrieved inter segment influence 521 from the prior (or all prior) segment paragraph output generations. In this way, the paragraph text generation for the present segment by a remote AI node 523 will be influenced by a random content, objective formatting, and prior generated paragraphs as a reader of the storybook might expect from a human storybook creation.

The generated paragraph text is delivered not only to the AI generated output 531 for assembly and presentation for the current page (segment), it is also processed by a local support processor 527 and added as inner segment influence 529 to be used to influence, for example, image generation for the current page. To accomplish the image generation, the processing and neural net circuitry 401 first extracts influence from the middle objective pattern 519, inter segment influence 521 and inner segment influence 529. Such influence being tailored and related to a remote AI node 543 that generates an image from textual input influence received from the local support processing node 541. Such influence may involve palette, brush strokes, painting style, content data (such as a “black haired boy with green eyes” and “toy train”), and so on. Although for this configuration all such influence is textual, but could as in other embodiments take different data type form as the remote AI node 543 might support such as within images.

Because in this configuration the generated image is only used for output presentation, the remote AI node 543 only delivers the generated page image to the output 531 for combination with the generated paragraph of page text from the remote AI node 532. Also, in this configuration, the only inner-segment influence flows via the inner segment influence 529 storage from the first AI generation sub-topology 503 to the second AI generation sub-topology 504.

At this point, the processing and neural net circuitry 401 in accordance with segment control processing code 535 directs places the generated output 531 into a presentation format for a child's review of the second page (i.e., the first middle page) and the segment flow pauses (i.e., enters a segment break period) awaiting the child's response. The child is offered, for example, a “next page” button and a “try again” button. From the child's response, from the input circuitry injection 537, the processing and neural network circuitry 401 either advances to the next middle segment (i.e., next page) generation as described above for generating the current middle segment in a cyclical manner until all of the middle segments (pages) have completed with at each segment break offering the child the option to regenerate or advance.

Should the child opt for a regeneration, the processing and neural network circuitry 401 responds by, for example, modifying the influence balancing and repopulating random elements within any pattern and replacing the current paragraph text and image with a new segment regeneration. Once every segment is advanced through, the processing and neural net circuitry 401 again advances but this time to prepare the final page/segment as illustrated in the following FIG. 6.

FIG. 6 is a combined schematic and functional diagram illustrating exemplary processing by the local and remote circuitry to generate the final segment of an overall AI generative objective after the plurality of middle segments have been completed as described with reference to FIG. 5. Specifically, the processing and neural net circuitry 401 begins by selecting from a last segment topology 609 a first AI generation sub-topology 603 that guides a first sub-segment generation of the last segment (last page of for example, a storybook).

Therein, a local support processing node 611 extracts and merges a last episode pattern 613, last objective pattern 615 and inter-segment influence 617 into a single influence flow that is delivered to a remote paragraph generating AI node 619. The influenced paragraph output is then delivered to be combined with the final image generated as part of a generated output 625. The influenced paragraph output is also delivered to a local support processing node 621. The local support processing node 621 prepares the influenced paragraph output for use as image influence data and stores such data as part of the inner-segment influence 623.

The processing and neural net circuitry 401 then turns to carry out the functionality of the image generation sub-segment by selecting an appropriate topology from the last segment topology 609 as illustrated to correspond to the second AI generation sub-topology 605. Therein, a local support processing node 635 gathers and merges, with balancing as needed, influence from selections from the last episode pattern 613, last objective pattern 615, inter-segment influence 617 and inner-segment influence 623. The local support processing node 635 delivers its output to influence the generation of a last page (last segment) image by a remote AI node 637. The generated image output is then stored within the memory circuitry 407, i.e., within the generated output 625. Thereafter, as with prior segments of the overall segmented AI generations, the processing and neural net circuitry 401 according to the segment control program code 535 delivers a final option to the child. Such final option is to regenerate the last page, close the storybook saving for later review, or to save the storybook and begin another episode of the storybook.

Although the storybook example was used and only two sub-segments per segment from all of the first, middle and final segments, varying numbers of sub-segments could have been used and of different generative output types and purposed could have been configured to support yet other types of overall segmented AI objectives. Likewise, many further options for even producing this storybook including, for example, using AI nodes to compare cross segment generated text could have been included to determine whether regenerations should occur automatically due to insufficient or too closely coupled correlation. The same could be applied to images generated, and so on. Other aspects described in reference to the prior and following figures could also be integrated in or replace aspects of the current configuration used for illustrative purposes only for FIGS. 4-6 as one of ordinary skill in the art will understand.

FIG. 7 is a schematic block diagram that illustrates an exemplary deployment of artificial intelligence elements in association with both input and output circuitry for use in influencing and triggering segmented generation and to minimize needs to configure input and output flow for each particular local configuration. Specifically, circuitry (such as for example that of the processing circuitry 105, the neural net circuitry 103 and the accelerator 107 of FIG. 1 depending on the configuration sought) functions to provide a plurality of AI input interfaces 703 each of which interface with any one or more of a plurality of input elements 705 (which may be circuit elements or devices). Similarly, the circuitry (which can be located in whole or in part within any one or many local and remote systems) also functions to provide a plurality of AI output interfaces 707 each of which interface with any one or more of a plurality of output elements 709. For illustration purposes, each of the AI output interfaces 707 are shown communicatively coupled with a one of the plurality of outputs elements 709 although more couplings are clearly possible.

The plurality of input elements 705 also provide a non-AI type of interface of a more traditional form, i.e., a driver based interface 711. Likewise, the plurality of output elements 709 also support a typical driver based interface 713. Thus, for example, additional system circuitry 715 per associated program code may choose to interface via an AI interface 707 or a traditional driver based interface 713 to any of the input elements 705 and the output elements 709. Such additional system circuitry 715 may comprise all or parts of the overall circuitry, e.g., parts or all of the processing circuitry 105, the neural net circuitry 103 and the accelerator 107 of FIG. 1.

Some software applications operating within the additional system circuitry 715 may continue to interface through the more traditional driver based interface pathways, but other software applications may choose to instead utilize an AI output or input interface pathway 709 or 703 to gain additional functionality (or avoid having to provide such functionality within the software application) along with avoiding specific tailoring needed to meet the requirements associated with the particular input and output elements 705 and 709 of a given device configuration. For example, within the input elements 705, we find a series of mechanisms to convey user input including keys 723, touch pads/screen 725, mouse 727, haptic pressure 729 and cameras 733. Together, these can be monitored by a single AI node, a user input AI interface node 753, that can be trained to deliver text data or other data flows with a plurality or a single convergent output that can be used to service application software as well as any overall segmented or unsegmented generative AI based objective. For example, it can act as a trigger causing the launch of a particular segment topology or a more typical software application that are available but inactive. It can also be used to interrupt a more typical software application or interrupt an ongoing overall generation objective currently underway. Such output of the user input AI interface 753 can also be used to influence future or ongoing AI generation carried out within the additional system circuitry 715.

Other examples set forth include a chemical input element 735 that drives a taste AI input interface 711 that, based on the chemical makeup data received, classifies the input to fit a framework associated with human taste senses. Similarly, the chemical input element 735 also drives a smell AI input interface 711 that, again based on the chemical makeup data received, classifies such input to fit a framework associated with human sense of smell. Odd or dangerous smells might then trigger a software application to alert a user, or a classification as frying fish might be used to influence a child's storybook generation or trigger a launch of a fish tale poem generative topology.

Motion detection elements 731 and camera elements 733 along with various other input elements 705, such as the chemical element 735, humidity element 737, GPS element 739 and temperature element 741, may together feed an environment AI input interface 759 that can deliver one or more generated outputs for various uses by the additional system circuitry 715. It can deliver influence on a sunny day and a car ride, by producing a group of influence text that form a background personalization of the child's storybook generating AI. The child visited the zoo earlier and based on all of the input element data flow, the environment AI input interface 759 when the child's storybook generator is launched later in the day, may have delivered influence output that will tailor a storybook segment generating topology to personalize its output relating to that zoo visit. Although not shown, internet based input could also be serviced in a similar manner. For example, of particular interest to a user, trending topics from internet searches might be accessed by another AI input interface 703 that is used to generate a pop-up paragraph highlighting the trend.

A microphone element 743 also can be serviced in a normal way through a typical interface such as the driver based interface 713. In addition, one or several AI input interfaces (e.g., such as a noise classification AI interface 761, sound classification AI interface 763, voice recognition AI interface 765 and music recognition AI interface 767) can be associated with the microphone element 743 to provide more enhanced functionality. The noise classification AI interface 761, for example, may be trained to recognize a breaking of a window sound. At the same time, a camera related AI input interface 703 (not shown) may also evaluate a feed from a camera element 733 to identify an intruder. Together, the intruder recognition and the sound of the breaking of the window trigger a software application launch that interacts with police. Further, a series of other AI interface elements may also be used to characterize and classify a feed from the microphone element 743 such as those mentioned above, or be serviced by a single AI input interface that may generate classification and identification output associated with noise, sound, voice, music and so on.

One or more communication elements 721, including various wired and wireless communication circuits, can be delivered to a communication AI input interface 751. The communication AI input interface 751 can generate output that can also trigger an application, a segmented topology generation, or modify an ongoing overall segmented generation objective. In addition, the communication AI input interface 751 may also participate as a decoding agent. For example, to avoid sending a high resolution image from a remote location to the communication input element 721, bandwidth can be conserved by downsizing the image and reducing the colorization, for example. Then, after sending this downsized and reduced image, the communication AI input interface 751 can be trained to convert such images back into a high resolution color in any upsizing needed to fit the capability of a display 789. Of course, such generated image will be lossy (that is, not identical to the original) but it may likely be sufficiently good enough to meet the needs of the user (even visually undetectable possibly) while dramatically reducing the overall communication pathway loading. This could apply to any communication flow as well such as video data.

Typical output driver based interfacing, such as that of the driver based interface 713, provides somewhat standard software interfaces to many vendors' particular versions of the output elements 709. Software programs then can ignore the peculiarities of one vendor versus another's output element 709 by interfacing through a common driver interface. The AI output interfaces 707 offer this functionality and more. Each of the AI output interfaces 707 also carry generative capability that not only drive the output elements 709 as mentioned by the driver based interface 713, but can also be trained to generate particular content to be used by the output elements 709 instead of relying of typical software program code having to produce the content.

The possibilities are endless. For example, a visual AI output interface 771 may receive any type or format of visual input data and is trained to generate a visual output data configured for the display 789. Visual input data may also be improved using generative techniques of the visual AI output interface 707 that prove of much higher quality than the original input. In addition, the visual AI output interface 771 may respond to internal system status, internet events, news or weather changes by automatically and independently generate a visual output for deliver to the display element 789.

Similarly, low quality audio perhaps of a single channel format could be converted to a five or seven speaker surround by an appropriately trained version of the audio AI output interface 773. Other versions of the audio AI output interface 773 responds for example to a mother's voice detection by the voice recognition AI input interface 765 or approaching footfall detection via the sound recognition AI input interface 763 both based on an audio feed from the microphone element 743. Such response may be to automatically hide a child's ongoing gaming session and deliver schoolwork to the screen.

Haptic input mismatches and personalization may also be carried out by the haptic AI output interface 775 via a haptics output element 791, as well as automatic generation of a haptic output based on other status or events associated with any part of the overall circuitry including that associated with any of the input elements 705, the AI input interfaces 703, other of the AI output interfaces 707, and goings on within the additional system circuitry 715. The same possibilities hold for all other AI output interfaces 707, such as smell 777, lighting 779, weather 781, temperature 783, and printer 785 AI output interfaces, which correspondingly service olfactory 792, lighting 793, weather 794, temperature 795 and printer 796 output elements. Such and other types of output elements can be found at remote locations as indicated by remote 797. To service such remote located output elements, a remote servicing AI output interface 787 interacts via remote communication pathways to reach the remote output elements 709.

The weather output element 794 might be used in virtual reality settings with wind, air conditioning and heating being directed at the user with a small room to simulate what is happening in a virtual world. To this end, the weather AI output interface 781 may be trained to respond to video data being delivered to the display element 789 to generate control over such wind and temperature based on the underlying weather indicated. The weather AI output interface 781 or the temperature AI output interface 783 may also be used to merely control thermostats inside the home. The smell AI output interface 777 might function in a similar way, by evaluating a game generated audio produced via the speakers 790 and picked up by the microphone element 743. The sound classifying AI input interface 763 might generate text identifying explosions or gunfire. This text may then be delivered to the smell AI output interface 777 (or directly via the driver based interface 713) that triggers generation by the olfactory producing element 792 of a release of a burnt gunpowder smell.

Of course, these are but a few possible examples wherein a software application or even a segment generating topology need not directly attempt to interact with any of the output elements 709. In fact, they may not be involved at all as the generative AI output interfaces 707 can be trained to self-generate output periodically or in response to detections related to local system, output element usages, and input element conditions. Regarding the segment generating topologies, both the AI input interfaces 703 and AI output interfaces 707 may inject influence, herein referred to as outside influence, that may cause termination, trigger a launch, modify segmented AI generation progression, or change all or portions of topologies thereof as described throughout this application.

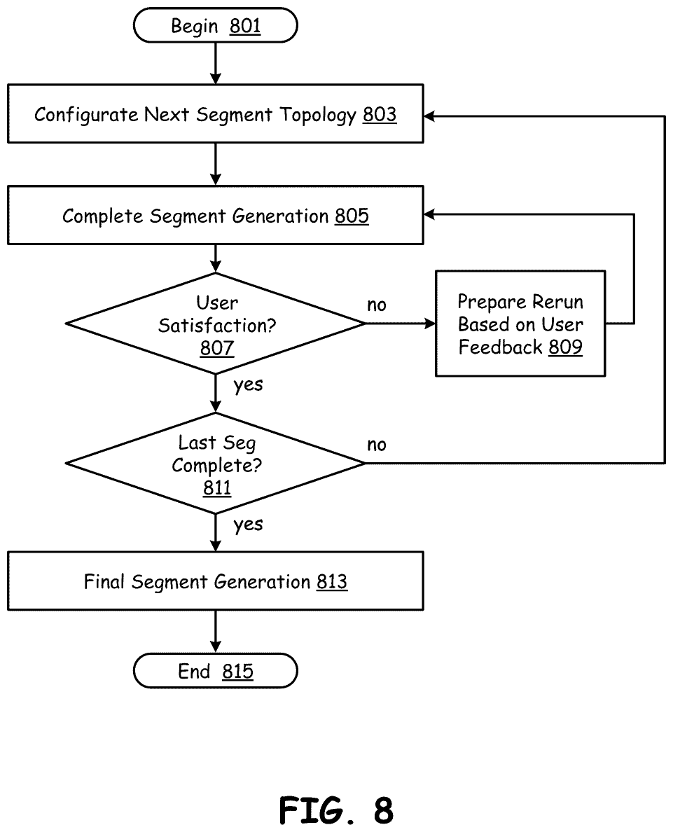

FIG. 8 is a flow diagram illustrating yet other aspects of the present invention in an exemplary segment by segment progression of an overall generation artificial intelligence objective carried out by circuitry such as that illustrated in FIG. 1, and where user feedback such as dissatisfaction with a segment generation can trigger a rerun of one, many or all prior generated segments and with user feedback being used to influence reruns. At a block 801, an overall segmented objective begins such as, for example, a generative creation of an illustrative novel where images and captioned text flow page to page, and where each page comprises a segment of output generation with sub-segment caption output and sub-segment image output.

At block 803, a single segment topology identify all sub-segments needed is identified by a circuit such as the processing circuitry 105 of FIG. 1. In accordance with the segment topology identified, each sub-segment output generation is carried with any needed inner segment influence (e.g., generated caption output influencing the image output) being applied to compete a full segment generation at the block 805. This full segment being the first page of the illustrative novel, for example.

At a block 807, a user is presented with a review opportunity. If the user likes the first segment (page), the user can choose to proceed with subsequent segment (page) generations. If not, based on user feedback collected at a block 809, the first page can be discarded in whole or in part and regenerated at the block 805 with the user feedback influencing such regeneration. Again, at the block 807, the user is given another opportunity to accept and continue or rerun the first page generation. Assuming this time that the first page is acceptable, the circuitry advances to block 811 where a last segment determination is made. If not the last segment (last page), the circuitry returns to block 803 to select a second segment topology and generates the second segment at the block 805. If the user finds the second segment (second page) unacceptable, the blocks 809 along with a discard and regeneration at the block 805 is conducted until an acceptable second segment proves satisfactory to the user at the block 807.

This cycle repeats until the circuitry reaches the last segment as determined at the block 811. Thereafter, when reached, the final segment generation occurs at the block 813. Of course, although not shown, the user can evaluate the last page and decide to reject or regenerate that in a loop fashion as well, and many other variations are contemplated. Also note that in this exemplary flow, there is a new segment topology selection option for each segment at the block 803. All segment topologies could be the same, but it is likely that they will vary over the course of attempting to complete the overall segmented generative objective in as satisfactory a manner to the user. An example of such variations across segments can be found with reference to FIGS. 4-6 above.

In the above illustrative novel example, a segment was selected to be a page in length. Various other segment sizes are contemplated. For example, for a typical novel, a segment might be a chapter and with a different topology for the first and last chapters from the middle chapters and so on. In fact, ever segment could have an entirely different topology that helps to best meet segment by segment expectations of a user.

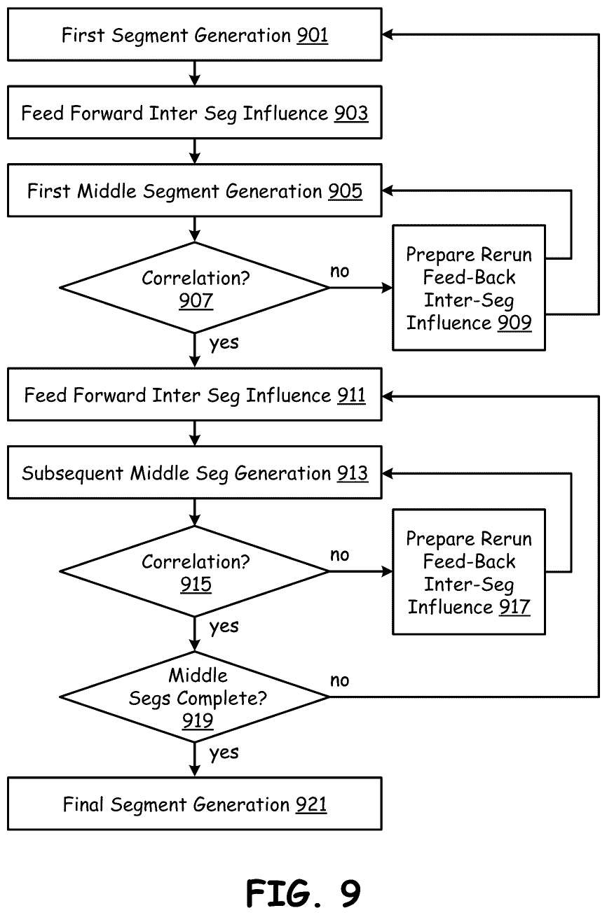

FIG. 9 is a flow diagram performed by circuitry that carries out an overall segmented AI generation such as that defined by the overall objective services specifications 113 (FIG. 1). That is, the flow diagram illustrates another exemplary segment by segment progression of an overall generation artificial intelligence objective, and wherein a rerun of one, many or all prior generated segments is triggered based a degree of correlation determination. Here, a first segment output is generated by an AI node at block 901. This first segment output generation may involve any of a plurality of sub-segment output generations that may be configured to accept inter sub-segment influence, i.e., where one sub-segment AI node generation influence another sub-segment AI node generation. Such sub-segment output influencing of another sub-sequent output generation is also referred to herein as inner segment influence, as the plurality of sub-segments together comprise a full segment.

In block 903, feed forward influence (i.e., inter segment influence) flows to a next segment to be generated at block 905. This may involve all or any one of the plurality of sub-segment output generations to be used to influence an AI node in its generation in a subsequent segment. Once the first middle segment generation has completed at least in part (at least for a portion of the plurality of sub-segment output generations), a comparison can be made between a prior and subsequent output generations to evaluate the degree of correlation at a block 907. If correlation proves insufficient, adjustments such as influence balancing and producing correlation related influence is delivered by the block 909 to either the block 901 or the block 905. If delivered to block 901, both the first segment generation and the first middle segment generation are discarded and the overall segmented generation starts again from the beginning with the influence and balancing produced at block 909 being applied. If instead, the circuitry at the block 909 decides to keep the first segment generation, only the first middle segment generation 905 is discarded and regenerated at the block 905 using the produced influence and balancing data from the block 909.

Once sufficient correlation is reached at block 907, the circuitry advances to begin processing the remainder of the middle segments. At 913, a subsequent middle segments is generated, and using inter-segment influence at block 911. The inter-segment influence of block 911 is based on at least a part (e.g., a sub-segment output generation) of the first middle segment output generation (and possibly also including influence from the first segment output generation 901 depending on the particular overall segmented generation objective at issue) is used to influence at least a part of the subsequent middle segment's output generation. A correlation sufficiency determination is made at the block 915 and, if not met, influence preparations and influence balancing occur at the block 917. After discarding the subsequent middle segment output generation, the subsequent middle segment output generation is rerun along with influence applied from the block 917. Also note that too much correlation may also not be good as there may not be adequate new matter added to make the current segment worthwhile. This too may trigger a branch to block 917 to prepare to regenerate a segment with perhaps rebalancing or otherwise reducing influence weight and impact.

This cycle of producing the middle segment output generations continues until determined to have finished with sufficient correlation at the block 919. All that remains in this exemplary segment to segment flow is to generate the final segment output at block 921. Note that this illustrated flow diagram is but one of many possibilities wherein inter segment influence drives a serial segment generation flow. However, it can be appreciated that parallel segment generations are also possible where inter segment influence is not needed. Similarly, even sub-segment generations can be in series to allow for inner segment influence. Or they can also be handled in parallel when inner segment influence is unneeded.

For example, with an overall goal of a storybook with each page having a paragraph of text and a closely correlating image, and, where such page constitutes a segment, we may find a text generating AI node that outputs generated text for a page that must track from page to page to follow a storyline to the last page. Within each page, the generated text influences creation of an image that is closely correlated so that the page text and page image are as expected by the child reader. As mentioned, the page output is a segment and can be generated on each indication of the child to turn the page or the entire storybook pages can be full pre-generated. Inner influence would thus be required within each page between a first sub-segment AI generation of page text which is then used in serial fashion to influence the image output of the second sub-segment AI generation of a page image. In addition, serialization of segment flow to accommodate inter segment influence is also needed. For example, the output text of a prior segment can be used to influence the generation of text in a current page text generation and so on.

Alternatively, for example in an adult's poetry book also requiring two sub-segment AI nodes to generate a page length poem to sit upon a background image, everything sub-segment and segment could be executed in parallel or even out of order. This would be because of the overall segmented generation objective associated with such adult poetry book. That is, for example, where an adult doesn't care that the images or the poems on a single page segment or across pages exhibit any correlated at all. In such a circumstance, even segmentation may be unnecessary unless a page by page generation is desired. For example, an infinitely long poetry book where a next page always generates yet another poem and image.

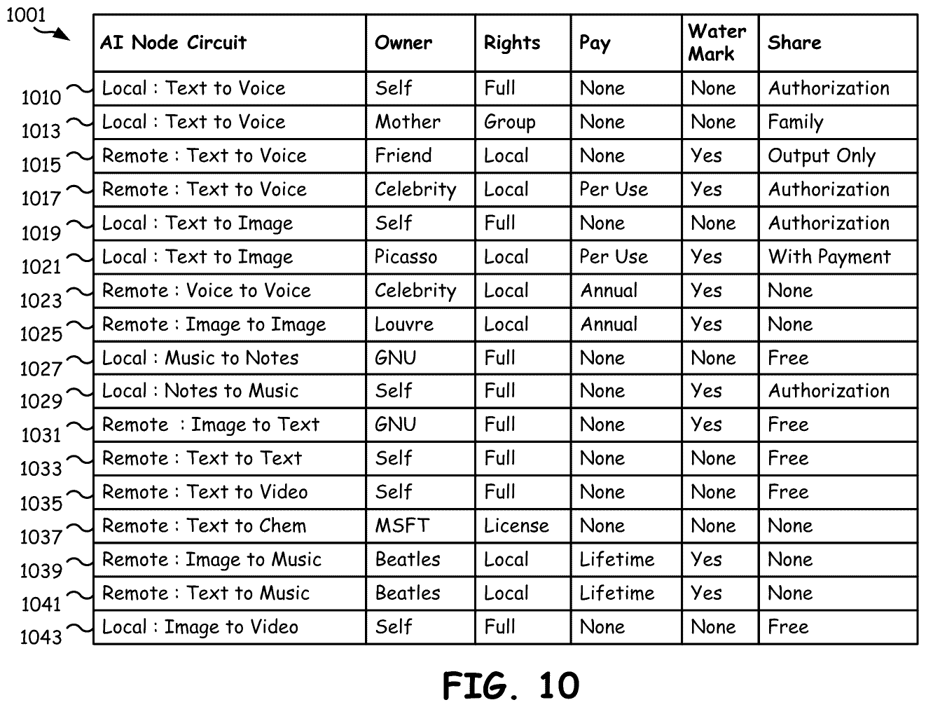

FIG. 10 is a structural database diagram illustrating digital rights management, authorization, payment collection, and usage control of artificial intelligence elements trained on particular users' owned training datasets that may be used in accordance with the present invention to address both privacy and ownership rights. In this exemplary database structure 1001, a plurality of database records (i.e., records 1011-1043) identify a corresponding plurality of different types of artificial intelligence (AI) nodes that are each associated with the identity of an owner, the owner's rights, payment acceptance offerings, watermarking requirements, and sharing authorizations granted.

More specifically, within a database record 1011, an AI node circuit field identifies a local AI node that is trained to generate voice that sounds like that of the user. Because of the user's privacy and safety concerns, within an owner, rights, pay, watermarking and sharing fields of the database record 1011, the user corresponding identifies the user as the owner, retains full ownership, accepts no payment for use, does not watermark, and will never share access to this trained AI node without authorization. The user of course can deploy this AI node locally. Delivering text results in the user's voice output generation.

Training has to be delivered to this text to user's voice generating AI. This may happen either in a single training session based only on generic voice data and associated text, or in a generic training initial session followed by a fine tuning training session using the user's voice data, for example. Once trained using the user's own voice data, the user gains ownership rights in the text to user's voice generating AI node illustrated within the database record 1011. With full rights, the user may choose a digital rights management approach to not only access to the AI node but also to any output generated therefrom.

Similarly, in a database record 1013, another AI node that runs locally is trained to produce the user's mother's voice from text input. As can be seen from the fields of the database record 1013, the mother has granted group rights (perhaps to her family members) without pay or watermarking requirements and allows shared access to the mother's voice generating AI node and its output. Likewise, a friend trained AI node identified in database entry 1015 is owned by a friend who requires watermarking of output but the user only has rights to output generated by the friend. A celebrity can also take advantage of their fame by training a text to that celebrity's voice AI node that can then be monetized. In particular, database record 1017 illustrates such a celebrity voice AI node that is only allowed to be used locally by the user by paying an annual fee with watermarked output and cannot be shared with others without authorization from the owner, i.e., the celebrity.

So many similar other variations of course span all kinds of AI node circuitry and their ownership and associated digital rights management configurations as illustrated within the exemplary set of database entries 1019 through 1043. Through personal data training, the underlying plurality of AI nodes identified in every record of the database 1001 confer ownership rights. In addition, creators of the untrained AI nodes may also retain ownership rights the extent of which involves an agreement between the creator and the human seeking to train their personalization into a creator's untrained AI node. In addition, if training involves a two-step process involving a 3^{rd} party human being the source for the baseline first pass training followed by the human that seeks fine tune training for their own personalization, such 3^{rd} party human may also retain an ownership right. This 3^{rd} party and untrained AI node creator may also reach an agreement wherein the 3^{rd} party rights are at least partially transferred to the creator of the untrained AI, such that the creator can convey adequate rights to the human seeking final tuning. Such rights of course involving use of the trained AI node and any future output generated by such fully trained AI node.

For example, a partially trained AI node may allow a user to fine tune train a creator's AI node but restricts usage of that tuned and fully trained AI node by a user's local device, but does allow generated output to be freely shared by the user. To gain distribution rights of access to the user's (e.g., a celebrity's) trained AI node, perhaps, for example, watermarking and payment accompaniment from others must occur.

When choosing a segment topology or segment sub-topology, for example, a decision to use one of the text to voice AI nodes of the database entries 1011, 1013, 1015 and 1017, involves a consideration of what the overall generation objective is all about and how will it be consumed or shared. For example, the processing circuitry 105 (FIG. 1) selects an option 1, local topology B within the middle segments 213 (FIG. 2) instead of a remote topology D option 3 so that a celebrity text to voice AI node can be used within local topology B. In other words, as topologies are selected and deployed, consideration is given to the digital rights associated with each underlying trained AI node. Moreover, if a user wants to circulate a text to voice generation publicly, they may be restricted to free to use text to voice generating AI nodes or their own text to user voice generations so long as they have full rights to do so. And for a particular need of text to voice generation, only the AI nodes that can meet the sharing and distribution (of output and access to personal trained AI nodes themselves) desires of a user are considered for an overall generation objective.

Of course, the list of database entries illustrated within the database 1001 are mere examples. Those of ordinary skill in the art will realize that extremely long lists will exist as users and vendors begin to supply voluminous numbers of fully trained and partially trained AI nodes for free and for paid access, and with all other types of DRM (digital rights management) constraints.

Various aspects of the present invention can be in an artificial intelligence infrastructure having circuitry that manages a plurality of segments of artificial intelligence generation. The circuitry carrying out this management of the plurality of segments of artificial intelligence generation via a corresponding plurality of topologies. Therein, at least a first of the corresponding plurality of topologies are different from a second of the corresponding plurality of topologies.

Other aspect can be found in another configuration of an artificial intelligence infrastructure wherein circuitry manages a plurality of segments of artificial intelligence generation to carry out an overall generation objective by employing a corresponding plurality of segment topologies. At least one of such plurality of segment topologies including a first artificial intelligence based sub-topology and a second artificial intelligence based sub-topology, and wherein the first artificial intelligence based sub-topology is different than the second artificial intelligence based sub-topology.

In another configuration, within the artificial intelligence infrastructure, circuitry manages a first of a plurality of segment generation with both a first portion generation based on a first artificial intelligence element and a second portion generation based on a second artificial intelligence element, wherein the first portion generation influences the second portion generation.

Other aspects can be found wherein an artificial intelligence infrastructure includes first circuitry and second circuitry. The first circuitry selects a subset of a plurality of artificial intelligence topology segments to support a segmented production of an overall generation objective of a user. The second circuitry produces first indication data before the overall generation objective has completed. The first circuitry responds to the first indication data by replacing at least part of the subset of the plurality of artificial intelligence based topology segments for use in completing the overall generation objective of the user.

Yet other various aspects of the present invention can be found in an artificial intelligence infrastructure wherein a first circuitry selects a subset of a plurality of artificial intelligence topology segments to support a segmented production of an overall generation objective, the segmented production involving a plurality of segment generations. The first circuitry also withholds a response to first indication data occurring during first generation of a first segment of the plurality of segment generations until after the first generation ends.

Another artificial intelligence infrastructure reveals other aspects of the present invention with a first circuitry that deploys a plurality of artificial intelligence topologies to carry out an overall segmented generation objective utilizing a plurality of segment generations. The first circuitry being configured to respond to first indication data by altering at least a portion of one of the plurality of artificial intelligence topologies before the overall segmented generation objective has completed.

Revealing yet other aspects, another artificial intelligence infrastructure input circuitry and first circuitry can be found. The first circuitry supports a plurality of artificial intelligence topology segments that together provide a segmented production of an overall generation objective. The first circuitry also supports a first artificial intelligence element communicatively coupled to the input circuitry, wherein the first artificial intelligence element generates first indication data associated with the input circuitry. The first circuitry responds to the first indication data by altering at least one aspect of the segmented production of the overall generation objective.

In a further configuration, within an artificial intelligence infrastructure, circuitry manages a first sub-segment topology and a second sub-segment topology to carry out a generated segment of an overall segmented artificial intelligence based objective. The circuitry also directs an initial sub-segment generation based on the first sub-segment topology followed by a subsequent sub-segment generation based on the second sub-segment topology. The circuitry selectively directs a regeneration of the initial sub-segment generation to increase correlation.

Further aspects may be found in an artificial intelligence infrastructure with circuitry configured to manage a first sub-segment topology and a second sub-segment topology in delivering a generated segment of an overall segmented artificial intelligence based objective. The circuitry direct an initial sub-segment generated output based on the first sub-segment topology followed by a subsequent sub-segment generated output based on the second sub-segment topology. Therein, the subsequent sub-segment generation being influenced by the initial sub-segment generated output.

In yet another configuration illustrating further aspects of the present invention, an artificial intelligence infrastructure has circuitry configured to support a first segment topology and a second segment topology that correspondingly deliver a first generated segment output and a second generated segment output of an overall segmented artificial intelligence based objective. Such circuitry directs the first generated segment output followed by the second generated segment output, and the second generated segment output being influenced by the first generated segment output.

Another configuration of the artificial intelligence infrastructure identifies various other aspects of the present invention. Therein, circuitry supports a plurality of segment topologies corresponding to a plurality of generated segments of an overall segmented artificial intelligence based objective. The circuitry selects a first of the plurality of segment topologies for generating a first of the plurality of generated segments, and the first of the plurality of generated segments being different from at least one other of the plurality of segment topologies.

Other aspects of the present invention can be found in yet another artificial intelligence infrastructure having circuitry configured to support an ordered sequence of segments to be generated based on artificial intelligence to deliver an overall segmented objective. Such circuitry directing both an out of order generation of the ordered sequence of segments and a reordering to meet the overall segmented objective.

Further aspects can be found in an artificial intelligence infrastructure having circuitry configured to support a plurality of artificial intelligence generated output corresponding to a plurality of segments of an overall segmented objective of a user. The circuitry supports adjustment of a plurality of types of influence data to be used to affect at least one of the plurality of artificial intelligence generated output.

Yet other aspects of the present invention can be found in an artificial intelligence infrastructure having circuitry configured to support a plurality of artificial intelligence generated output corresponding to a plurality of segments of an overall segmented objective. The overall segmented objective having a characteristic flow represented by a plurality of pattern sets that correspond to the plurality of segments. The circuitry applying the plurality of pattern sets to correspondingly influence the plurality of artificial intelligence generated output.

Another configuration of an artificial intelligence infrastructure reveals yet other aspects of the present invention by employing circuitry that supports a plurality of artificial intelligence generated output corresponding to a plurality of segments of a plurality of episodic segmented objectives. The plurality of episodic segmented objectives having a corresponding plurality of episode data. The circuitry being configured to apply the plurality of episode data to influence the plurality of artificial intelligence generated output.

Illustrating yet other aspects of the present invention, within an artificial intelligence infrastructure, circuitry supports a plurality of artificial intelligence generated output corresponding to a plurality of segments of an overall segmented objective. The circuitry applies an element of personal randomization to influence at least one of the plurality of artificial intelligence generated output.

Further aspects can be found in an artificial intelligence infrastructure with first circuitry that selects at least one node within a first of a plurality of artificial intelligence topology segments that together deliver an overall segmented generation objective. The first circuitry being configured to perform the selection of the at least one node by evaluating usage rights in associated underlying data.

Other aspects may be found within artificial intelligence infrastructure having output circuitry and first circuitry. The first circuitry supports a first artificial intelligence element communicatively coupled to the output circuitry. The first artificial intelligence element responding to the first data by generating output that is delivered to the output circuitry.

Further, within another artificial intelligence infrastructure other aspects of the present invention can be found. Such infrastructure including output circuitry that has both a direct interface and an artificial intelligence based interface. First application software communicates via the direct interface to the output circuitry, while second application software communicates via the artificial intelligence based interface. Therein, the artificial intelligence element responds to the second application software by generating output data that is delivered to the output circuitry.

In addition, although throughout this specification selected exemplary embodiments have been used to illustrate particular aspects of the present invention, all of these aspects are contemplated as being combinable into a single embodiment or extracted into any subset of such aspects into enumerable other embodiments. Thus, the boundaries of each embodiment regarding particular aspects included therein are merely for illustrating operation of a select group of aspects and are in no way considered to limit the overall breadth of such aspects or the ability of combining them as so desired and as one of ordinary skill in the art can surely contemplate after receiving the teachings herein.

The terms “circuit” and “circuitry” as used herein may refer to an independent circuit or to a portion of a multifunctional circuit that performs multiple underlying functions. For example, depending on the embodiment, processing circuitry may be implemented as a single chip processor or as a plurality of processing chips. It may also include neural network circuit elements, accelerators supporting software AI models. Likewise, a first circuit and a second circuit may be combined in one embodiment into a single circuit or, in another embodiment, operate independently perhaps in separate chips. The term “chip,” as used herein, refers to an integrated circuit. Circuits and circuitry may comprise general or specific purpose hardware, or may comprise such hardware and associated software such as firmware or object code.

As one of ordinary skill in the art will appreciate, the terms “operably coupled” and “communicatively coupled,” as may be used herein, include direct coupling and indirect coupling via another component, element, circuit, or module where, for indirect coupling, the intervening component, element, circuit, or module may or may not modify the information of a signal and may adjust its current level, voltage level, and/or power level. As one of ordinary skill in the art will also appreciate, inferred coupling (i.e., where one element is coupled to another element by inference) includes direct and indirect coupling between two elements in the same manner as “operably coupled” and “communicatively coupled.”

The present invention has also been described above with the aid of method steps illustrating the performance of specified functions and relationships thereof. The boundaries and sequence of these functional building blocks and method steps have been arbitrarily defined herein for convenience of description, and can be apportioned and ordered in different ways in other embodiments within the scope of the teachings herein. Alternate boundaries and sequences can be defined so long as certain specified functions and relationships are appropriately performed/present. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block/step boundaries and sequence could have been defined otherwise and still perform the certain significant functionality. Such alternate definitions of both functional building blocks and flow diagram blocks and sequences are thus within the scope and spirit of the claimed invention.

One of average skill in the art will also recognize that the functional building blocks, and other illustrative blocks, modules and components herein, can be implemented as illustrated or by discrete components, application specific integrated circuits, processors executing appropriate software and the like or any combination thereof. Although the Internet is taught herein, the Internet may be configured in one of many different manners, may contain many different types of equipment in different configurations, and may be replaced or augmented with any network or communication protocol of any kind.

Moreover, although described in detail for purposes of clarity and understanding by way of the aforementioned embodiments, the present invention is not limited to such embodiments. It will be obvious to one of average skill in the art that various changes and modifications may be practiced within the spirit and scope of the invention, as limited only by the scope of the appended claims.

What is claimed is:

1-18. (canceled)

19. An artificial intelligence infrastructure, comprising:
first circuitry configured to select a subset of a plurality of artificial intelligence topology segments to support a segmented production of an overall generation objective of a user;
second circuitry configured to produce first indication data before the overall generation objective has completed; and
the first circuitry being configured to respond to the first indication data by replacing at least part of the subset of the plurality of artificial intelligence based topology segments for use in completing the overall generation objective of the user.

20. The artificial intelligence infrastructure of claim 19, wherein:
the first circuitry is operable to provide the overall generation objective and the replacement using segmented and sub-segmented topologies.

21. The artificial intelligence infrastructure of claim 19, wherein:
a varying sub-segment count specification is operable to define replaceable segment types comprising one or more of an index page, a subscription offer, a mixed advertiser segment, and an article.

22. The artificial intelligence infrastructure of claim 19, wherein:
a dual sub-segment specification is operable to support a generation of each page of a document as a replaceable segment with text and image generation handled by separate sub-segments.

23. The artificial intelligence infrastructure of claim 19, wherein:
the overall generation objective is to generate one of:
an electronic storybook,
a sales brochure, and
a magazine.

24. An artificial intelligence infrastructure, comprising:
first circuitry configured to deploy a plurality of artificial intelligence topologies to carry out an overall segmented generation objective utilizing a plurality of segment generations; and
the first circuitry being configured to respond to first indication data by altering at least a portion of one of the plurality of artificial intelligence topologies before the overall segmented generation objective has completed.

25. The artificial intelligence infrastructure of claim 24, wherein:
the first circuitry is operable to provide the overall generation objective and the replacement using segmented and sub-segmented topologies.

26. The artificial intelligence infrastructure of claim 24, wherein:
a varying sub-segment count specification is operable to define replaceable segment types comprising one or more of an index page, a subscription offer, a mixed advertiser segment, and an article.

27. The artificial intelligence infrastructure of claim 24, wherein:
a dual sub-segment specification is operable to support a generation of each page of a document as a replaceable segment with text and image generation handled by separate sub-segments.

28. The artificial intelligence infrastructure of claim 24, wherein:
the overall generation objective is to generate one of:
an electronic storybook,
a sales brochure, and
a magazine.

29. An artificial intelligence infrastructure, comprising:
input circuitry;
first circuitry configured to support a plurality of artificial intelligence topology segments that together provide a segmented production of an overall generation objective;
the first circuitry configured to support a first artificial intelligence element communicatively coupled to the input circuitry, the first artificial intelligence element generating first indication data associated with the input circuitry; and
the first circuitry being configured to respond to the first indication data by altering at least some aspect of the segmented production of the overall generation objective.

30. The artificial intelligence infrastructure of claim 29, wherein:
the first circuitry is operable to provide the overall generation objective and the altering using segmented and sub-segmented topologies.

31. The artificial intelligence infrastructure of claim 29, wherein:
a varying sub-segment count specification is operable to define alterable segment types comprising one or more of an index page, a subscription offer, a mixed advertiser segment, and an article.

32. The artificial intelligence infrastructure of claim 29, wherein:
a dual sub-segment specification is operable to support a generation of each page of a document as a alterable segment with text and image generation handled by separate sub-segments.

33. The artificial intelligence infrastructure of claim 29, wherein:
the overall generation objective is to generate one of:
an electronic storybook,
a sales brochure, and
a magazine.

34. An artificial intelligence infrastructure, comprising:
circuitry configured to manage a first sub-segment topology and a second sub-segment topology to carry out a generated segment of an overall segmented artificial intelligence based objective;
the circuitry being configured to direct an initial sub-segment generation based on the first sub-segment topology followed by a subsequent sub-segment generation based on the second sub-segment topology; and
the circuitry being further configured to selectively direct a regeneration of the initial sub-segment generation to increase correlation.

35. The artificial intelligence infrastructure of claim 34, wherein:
the circuitry is operable to provide the overall generation objective and the regeneration using segmented and sub-segmented topologies.

36. The artificial intelligence infrastructure of claim 34, wherein:
a varying sub-segment count specification is operable to define regenerated segment types comprising one or more of an index page, a subscription offer, a mixed advertiser segment, and an article.

37. The artificial intelligence infrastructure of claim 34, wherein:
a dual sub-segment specification is operable to support a generation of each page of a document as a regenerated segment with text and image generation handled by separate sub-segments.

38. The artificial intelligence infrastructure of claim 34, wherein:
the overall generation objective is to generate one of:
an electronic storybook,
a sales brochure, and
a magazine.
